(19) United States
(12) Patent Application Publication
(10) Pub. No.: US 2017/0125911 A1
(43) Pub. Date: May 4, 2017

(54) PARITY-TIME SYMMETRIC METASURFACES AND METAMATERIALS

(71) Applicant: Board of Regents, The University of Texas System, Austin, TX (US)

(72) Inventors: Andrea Alu, Austin, TX (US); Romain Fleury, Austin, TX (US); Dimitrios Sounas, Austin, TX (US)

(73) Assignee: Board of Regents, The University of Texas System, Austin, TX (US)

(21) Appl. No.: 15/318,182

(22) PCT Filed: May 28, 2015
(86) PCT No.: PCT/US15/32875

§ 371 Date: Dec. 12, 2016

Related U.S. Application Data
(60) Provisional application No. 62/013,069, filed on Jun. 17, 2014.

(51) Int. Cl. H01Q 13/10; H01Q 15/00

(52) U.S. Cl. CPC H01Q 13/103; H01Q 15/0086

(57) ABSTRACT

A metamaterial device exploiting parity-time symmetry to achieve ideal loss compensation. The metamaterial device includes metamaterials and metasurfaces that are engineered to respect space-time inversion symmetry, i.e., that are invariant after taking their mirror image and running time backwards. One such metamaterial device utilizes two resonators with loss and gain that exactly compensate each other thereby causing the metamaterial device to be invisible when excited from one side of the metamaterial device and reflective when excited from the other side of the metamaterial device. Furthermore, a metamaterial device may include an object covered by a portion of a metasurface with loss and another portion of the metasurface with gain, where the loss and gain exactly compensate each other. The first portion of the metasurface absorbs all of an incident wave, whereas, the second portion of the metasurface re-emits the incident wave.

### CROSS REFERENCE TO RELATED APPLICATIONS

This application claims priority to U.S. Provisional Patent Application Ser. No. 62/013,069, entitled “Parity-Time Symmetric Metasurfaces and Metamaterials,” filed on Jun. 17, 2014, which is incorporated by reference herein in its entirety.

### GOVERNMENT INTERESTS

This invention was made with government support under Grant No. FA9550-13-1-0204 awarded by the Air Force Office of Scientific Research (AFOSR), Grant No. HDTRA1-12-1-0022 awarded by the Defense Threat Reduction Agency (DTRA) and Grant No. FA9550-11-1-0009 awarded by the AFOSR Young Investigator Research Program (YIP). The U.S. government has certain rights in the invention.

### TECHNICAL FIELD

The present invention relates generally to metamaterials, and more particularly to parity-time symmetric metasurfaces and metamaterials.

### BACKGROUND

Metamaterials are artificially structured materials possessing exotic electromagnetic or acoustic properties that are not readily available in nature, for example, a negative, a zero, or a very large index of refraction. They are associated with unusual physical phenomena with exciting potentials for applications, including negative refraction, cloaking and super-lensing. Currently, their exotic properties have been typically induced by exploiting passive structural resonances, leading to an inherently narrow-band, and loss-sensitive response. These drawbacks drastically limit their performance and applicability.

### BRIEF SUMMARY

In one embodiment of the present invention, a metamaterial device comprises a first and a second element with loss and gain, respectively, that exactly compensate each other, where an amount of the loss and the gain for the first and second elements, respectively, is tuned by loading the first and second elements with impedances. In response to tuning the amount of the loss and the gain, the metamaterial device is invisible when excited from one side of the metamaterial device and reflective when excited from the other side of the metamaterial device.

In another embodiment of the present invention, a metamaterial device comprises an outer surface of an object surrounded by a first portion of a metasurface with loss and the outer surface of the objected surrounded by a second portion of the metasurface with gain. The loss and the gain exactly compensate each other, where the first portion of said metasurface absorbs all of an incident wave and the second portion of the metasurface re-emits the incident wave thereby making the object non-scattering or cloaked.

In another embodiment of the present invention, a metamaterial device comprises a first metasurface with loss and a second metasurface with gain, where the gain and the loss compensate each other. The first and second metasurfaces have opposite conjugate surface impedances. A transverse-electric polarized light beam or plane wave obliquely incident on the first and second metasurfaces undergoes negative refraction in free space.

In another embodiment of the present invention, a metamaterial device comprises a first metasurface with loss and a second metasurface with gain, where the gain and the loss compensate each other. The first and second metasurfaces have opposite conjugate surface impedances thereby realizing a lensing or focusing or imaging system.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIGS. 1A-1B illustrate a parity-time invisible acoustic sensor in accordance with an embodiment of the present invention;

FIG. 2A illustrates the desired PT-symmetric density distribution in accordance with an embodiment of the present invention;

FIG. 2B is a two-port transmission-line model of the acoustic system of FIGS. 1A-1B, composed of two lumped elements with resistance +R and −R, separated by a portion of a transmission line of acoustic length x and characteristic impedance Z₀ in accordance with an embodiment of the present invention;

FIG. 2C is a graph showing the scattering parameters as a function of the parameter r=R/Z₀, for x=sin⁻¹(1/4) in accordance with an embodiment of the present invention;

FIG. 3A illustrates the normalized acoustic impedance of the loaded loudspeaker at port 1 of the acoustic system of FIGS. 1A-1B as a function of frequency in accordance with an embodiment of the present invention;

FIG. 3B illustrates the normalized acoustic impedance of the loaded loudspeaker at port 2 of the acoustic system of FIGS. 1A-1B as a function of frequency in accordance with an embodiment of the present invention;

FIG. 3C illustrates the magnitude of the scattering parameters of the acoustic system of FIGS. 1A-1B as a function of frequency in accordance with an embodiment of the present invention;

FIG. 3D illustrates the phase of the scattering parameters of the acoustic system of FIGS. 1A-1B as a function of frequency in accordance with an embodiment of the present invention;

FIG. 3E illustrates the acoustic pressure distribution in the device of FIGS. 1A-1B (snapshot in time) when excited at if =250 Hz by a wave incident from ports 1 (top) and 2 (bottom) in accordance with an embodiment of the present invention;

FIG. 4A illustrates a fabricated PT acoustic device showing the two loaded loudspeakers connected to non-Foster electrical circuits in accordance with an embodiment of the present invention;

FIG. 4B illustrates the PT acoustic system placed between two waveguides in accordance with an embodiment of the present invention;

FIG. 4C illustrates the measured magnitude of the scattering parameters in accordance with an embodiment of the present invention;

FIG. 4D illustrates the measured phase of the scattering parameters in accordance with an embodiment of the present invention;

FIG. 4E illustrates the comparison between the power absorbed by the passive loudspeaker to the total power scattered by the device, measured in the resistive circuit, in accordance with an embodiment of the present invention;

FIG. 5 is a table (Table 1) that lists the mechanical and electrical properties for the loudspeakers given by the manufacturer, also known as Thiele and Small parameters, in accordance with an embodiment of the present invention;

FIG. 6 illustrates the electrical load for the +R loudspeaker in accordance with an embodiment of the present invention;

FIG. 7 is a table (Table 2) of the values of the electrical components used in the electrical loads in accordance with an embodiment of the present invention;

FIG. 8 illustrates the electrical load for the −R loudspeaker in accordance with an embodiment of the present invention;

FIG. 9 illustrates a PEC cylinder covered with a PT-symmetric surface in accordance with an embodiment of the present invention;

FIG. 10A shows the electric field and power distribution for a half-cloaked cylinder from its left-hand (lossy) side in accordance with an embodiment of the present invention;

FIG. 10B shows the electric field and the power distribution for a fully-cloaked cylinder in accordance with an embodiment of the present invention;

FIG. 10C shows the electric field and power distribution of a bare cylinder in accordance with an embodiment of the present invention;

FIG. 11 shows the electric field and power distribution in the case of a fully-cloaked cylinder for incidence from the −x direction in accordance with an embodiment of the present invention;

FIG. 12 illustrates a PEC rhomboidal cylinder covered with a PT-symmetric metasurface in the form of a rhomboidal cylinder in accordance with an embodiment of the present invention;

FIG. 13A presents the electric field and power distribution in the case of a PT-symmetric cloaked rhomboid with an opening of 90°, a=10λ and d=0.05λ in accordance with an embodiment of the present invention;

FIG. 13B presents the electric field and power distribution in the case of a bare rhomboid with a=10λ in accordance with an embodiment of the present invention;

FIG. 13C presents the electric field and power distribution in the case of a PT-symmetric cloaked rhomboid with a=10λ and d=0.05λ in accordance with an embodiment of the present invention;

FIG. 13D presents the electric field and power distribution in the case of a bare rhomboid with a=20λ in accordance with an embodiment of the present invention;

FIG. 14A shows conventional negative refraction in a passive DNG slab for light rays emitted by a source placed on the left side of the slab in accordance with an embodiment of the present invention;

FIG. 14B illustrates negative refraction using PT-symmetric metasurfaces with real surface impedances +R and −R in accordance with an embodiment of the present invention;

FIG. 15A illustrates the equivalent circuit for the geometry of FIG. 14B in accordance with an embodiment of the present invention;

FIG. 15B shows the magnitude of S₁₁ in accordance with an embodiment of the present invention;

FIG. 15C shows the magnitude of S₂₂ in accordance with an embodiment of the present invention;

FIG. 15D shows the magnitude of S₂₁, S₁₁ in accordance with an embodiment of the present invention;

FIG. 16A shows a snapshot in time of the transverse component of the electric field E_{z} in the case of a plane wave normally incident from the left on a pair of metasurfaces with R=±0.5η₀ in accordance with an embodiment of the present invention;

FIG. 16B shows a snapshot in time of the transverse component of the electric field E_{z} in the case of an obliquely incident plane wave in accordance with an embodiment of the present invention;

FIG. 16C shows a snapshot in time of the transverse component of the electric field E_{z} in the case of an obliquely incident Gaussian beam in accordance with an embodiment of the present invention;

FIG. 17A illustrates focusing a point source to a spot whose transverse size is close to the wavelength when the surface impedance Z is constant at 0.5 ηₒ in accordance with an embodiment of the present invention; and

FIG. 17B illustrates an inhomogeneous surface impedance focusing all propagating spatial harmonics, resulting in a spot size with a transverse size equal to λₒ/2 in accordance with an embodiment of the present invention.

### DETAILED DESCRIPTION

As stated in the Background section, metamaterials are artificially structured materials possessing exotic electromagnetic or acoustic properties that are not readily available in nature, for example, a negative, a zero, or a very large index of refraction. They are associated with unusual physical phenomena with exciting potentials for applications, including negative refraction, cloaking and super-lensing. Currently, their exotic properties have been typically induced by exploiting passive structural resonances, leading to an inherently narrow-band, and loss-sensitive response. These drawbacks drastically limit their performance and applicability.

The principle of the present invention provides a solution to these issues that allows realizing completely loss-compensated and broadband wave manipulation, by exploiting the largely uncharted scattering properties of Parity-Time (PT) symmetric systems. As discussed below, metamaterials and metasurfaces that are engineered to respect a space-time inversion symmetry—i.e., that are invariant after taking their mirror image and running time backwards—can lead to exotic wave phenomena as conventional metamaterials, but without all their bandwidth and loss related issues. Furthermore, preliminary experimental results for acoustic waves are discussed, proving that such a loss-compensation technique is viable and within technological reach, demonstrating an invisible acoustic sensor that can absorb power levels comparable to the incident field. Furthermore, strategies are proposed to apply this new paradigm to both acoustic and electromagnetic waves, using ultrathin PT-symmetric metasurfaces that may achieve, in a completely loss-immune and broadband fashion, a Veselago lens and an invisibility cloak.

When one measures a physical quantity of interest, its spatial distribution is intrinsically perturbed, creating reflections and a shadow associated with the energy extracted by the measurement. The larger the signal picked up with a sensor, the greater the wave scattering is typically generated. It has been recently suggested that this problem may be overcome using metamaterial cloaks, which may avoid the scattering of a sensor, while at the same time maintaining its ability to receive energy from the surrounding. However, power conservation arguments require that any passive object is bound to generate a finite shadow proportional to the amount of absorbed energy, and low scattering can only be achieved at the price of minimal absorption. In contrast, as discussed further below, the principles of the present invention encompass an ideally non-invasive, fully invisible metamaterial sensor, with no shadow, at the same time able to fully absorb the incoming signal.

This functionality may be achieved by properly pairing an active and a passive sub-system with balanced absorption and gain properties. The concept is inspired to recent advances in modern theoretical physics, in which significant attention has been devoted to non-Hermitian Hamiltonians H that commute with the parity-time (PT) operator, a property that can lead to real energy eigenvalues. Translated to optics, it has been theoretically argued that PT-symmetric systems, obtained with properly balanced distributions of absorbing and gain media, may produce lossless propagation, remarkably leading to loss compensation, and, under special conditions, unidirectional invisibility in 1-D systems. However, because of the technological difficulties in fabricating stable distributions of gain media in optics, experimental investigations of these exotic scattering phenomena have so far been restricted to the temporal domain, or to completely passive spatial distributions of refractive index that resemble, but are not inherently PT-symmetric.

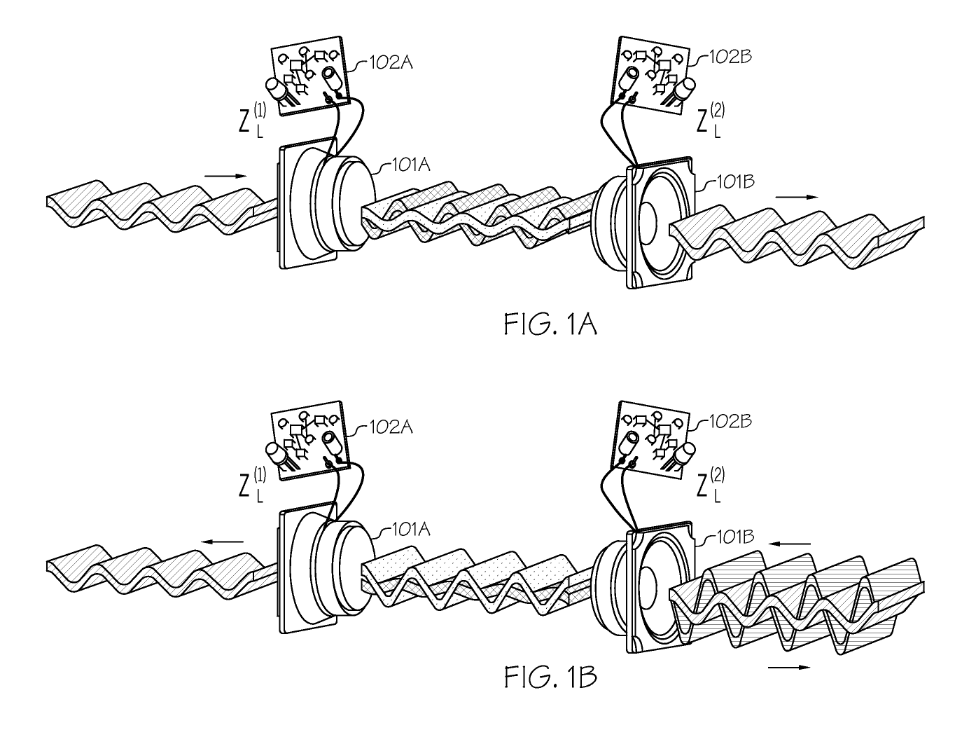

By extending these concepts to sound waves, the principles of the present invention use parity-time symmetry to realize a completely non-invasive, invisible acoustic sensor based on a PT-symmetric distribution of balanced gain and loss, which also constitutes the first experimental evidence of PT-symmetric unidirectional invisibility for sound. The proposed concept is schematically represented in FIGS. 1A-1B. FIGS. 1A-1B illustrate a parity-time invisible acoustic sensor in accordance with an embodiment of the present invention. Referring to FIGS. 1A-1B, a PT-symmetric acoustic system is realized by using a pair of electromechanical resonators 101A-101B (loudspeakers are used as exemplary resonators in FIGS. 1A-1B) loaded with properly tailored electrical circuits 102A-102B, respectively. Loudspeaker 101A is operated as a sensor by loading it with an absorptive circuit 102A, while loudspeaker 101B forms an acoustic gain element. Their combination is a compact PT-symmetric unit cell that is transparent from the left as shown in FIG. 1A, while it can at the same time extract the impinging signal. On the contrary, the system is highly reflective when excited from the right as shown in FIG. 1B.

In order to extract energy from the incoming sound wave, a conventional acoustic sensor 101A (FIG. 1A) was used in the form of a loudspeaker connected to electric circuit 102A with impedance Z_{L} that is tailored to absorb a portion of the impinging signal. This sensor, by itself, would inherently produce a shadow associated with the power that it absorbs, as well as some reflections and scattering. In order to realize an invisible sensor, without reflections or shadows, a second loudspeaker 101B (FIG. 1A) was cascaded at distance d, loaded with an active electrical circuit 102B tailored to realize the time-reversed image of the left sensor, forming a compact, unidirectionally invisible, PT-symmetric acoustic device. This PT metamaterial cell lets acoustic energy flow totally undisturbed, without reflections or shadows, when excited from the left (FIG. 1A): while the first (sensing) loudspeaker 101A absorbs the impinging energy, the second (active) loudspeaker 101B restores the energy balance. When excited from the active side, such a device is instead strongly reflective (FIG. 1B), consistent with the strongly asymmetric response typically expected in PT-symmetric systems.

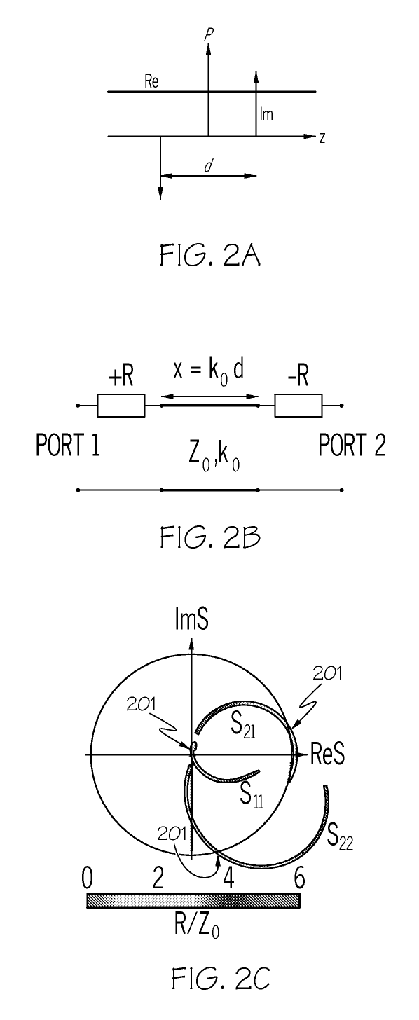

As far as the theory, for practical purposes, the PT-symmetric invisible sensor is envisioned enclosed in an acoustic waveguide consisting of a straight air-filled pipe with hard solid walls. The loudspeakers may be modeled as transverse mechanical resonators that modify the local effective density of the acoustic medium, with minimal effects on its effective bulk modulus. The circuit impedance loading the two loudspeakers is tailored to synthesize a one-dimensional acoustic metamaterial cell whose effective density distribution ρ(z) has a homogeneous real part equal to the background density ρ₀, while its imaginary part (shown below in Equation (1)) follows the odd-symmetric distribution as illustrated in FIG. 2A. FIG. 2A illustrates the desired PT-symmetric density distribution in accordance with an embodiment of the present invention.

Imρ=ρ_{L}[δ(z−d/ 2)δ(z+d/2)]. (1)

Since both P and T operators have the effect of switching the sign of the imaginary part of the density, it is easily seen that this spatial distribution is indeed PT-symmetric, as desired. Such a unit cell can be modeled using an equivalent two-port transmission-line model, as shown in FIG. 2B, where FIG. 2B is a two-port transmission-line model of the acoustic system of FIGS. 1A-1B, composed of two lumped elements with resistance +R and −R, separated by a portion of a transmission line of acoustic length x and characteristic impedance Zₒ in accordance with an embodiment of the present invention.

Referring to FIG. 2B, the loudspeakers are represented as series lumped elements, surrounded by transmission-line segments of impedance Z₀=\sqrt{ρ₀ κ₀}/S₀, representing the waveguide portions, with κ₀ being the background bulk modulus and S₀ the waveguide cross-section. The acoustic separation length x=k₀d, where k₀ is the free-space wave number. In order to synthesize the effective density distribution (Equation (1)) the loading circuits should be chosen such that the first loudspeaker is characterized by a passive resistance R=ρ_{L}ω/S₀, while the second one supports acoustic gain with negative resistance −R. As a result, activity circuitry may be used, such as via the use of non-Foster circuit elements. In one embodiment, such active circuit elements are suitably designed to guarantee full acoustic stability, avoiding unwanted oscillations. The scattering matrix of the metamaterial cell in FIG. 2B can be calculated using a transmission-matrix approach:

$$S = ( \begin{matrix}\frac{r ( r - 2 ) sin ( x )}{{r}^{2} sin ( x ) + 2 j {e}^{j x}} & \frac{2 j}{{r}^{2} sin ( x ) + 2 j {e}^{j x}} \\ \frac{2 j}{{r}^{2} sin ( x ) + 2 {je}^{i x}} & \frac{r ( r + 2 ) sin ( x )}{{r}^{2} sin ( x ) + 2 {je}^{j x} }\end{matrix} ) , \qquad ( 2 )$$

where r=R/Z₀. Equation (2) describes a reciprocal and linear system that possesses interesting scattering properties as a function of the values of r and x. FIG. 2C, for instance, shows the effect of varying r=R/Z₀ on the evolution of the scattering parameters in the complex plane for x=sin⁻¹(1/4). In particular, FIG. 2C is a graph showing the scattering parameters as a function of the parameter r=R/Z₀, for x=sin⁻¹(1/4) in accordance with an embodiment of the present invention. As illustrated in FIG. 2C, a unidirectional invisible device is obtained for r=2 (see arrows 201). As further illustrated in FIG. 2C, the various shades show the scattering evolution as the parameter r is varied, as indicated in the legend.

A condition of special interest is given by r=2 (highlighted in the panel by arrows 201), for which unidirectional transparency is obtained, with zero reflection at port 1 (S₁₁=0), unitary reflection at port 2 (|S₂₂|=1), and unitary transmittance at both ports |S₁₂|=|S₂₁|. This unidirectional reflectionless response is actually independent of the distance x, as it can be seen by evaluating the scattering matrix (2) for r=2:

$$S = ( \begin{matrix}0 & {e}^{j x} \\ {e}^{j x} & 2 - 2 {e}^{2 j x}\end{matrix} ) . \qquad ( 3 )$$

Such a system therefore realizes an acoustic sensor that is ideally invisible when excited from one side, with no reflections and unitary transmission, but strongly reflects when excited from the other side, consistent with the sketch in FIGS. 1A-1B. The passive (left) portion of the device efficiently absorbs the impinging signal, while the active (right) portion provides the required energy to suppress any shadow. Quite interestingly, and in contrast to previous theoretical studies on unidirectional invisibility in PT-symmetric structures, transmission here is accompanied by a phase advance that is exactly opposite to the phase the wave would acquire over the distance x in the background medium, implying that the proposed system effectively realizes an impedance matched, negative-index metamaterial unit cell for arbitrary distance x.

Because of the appealing scattering features occurring at the exceptional point r=2, the two loudspeakers and their circuit loads are tailored to fulfill this condition at their resonance frequency fᵣ=250 Hz. Geometry, materials, and design procedures of the PT-symmetric metamaterial cell are detailed below.

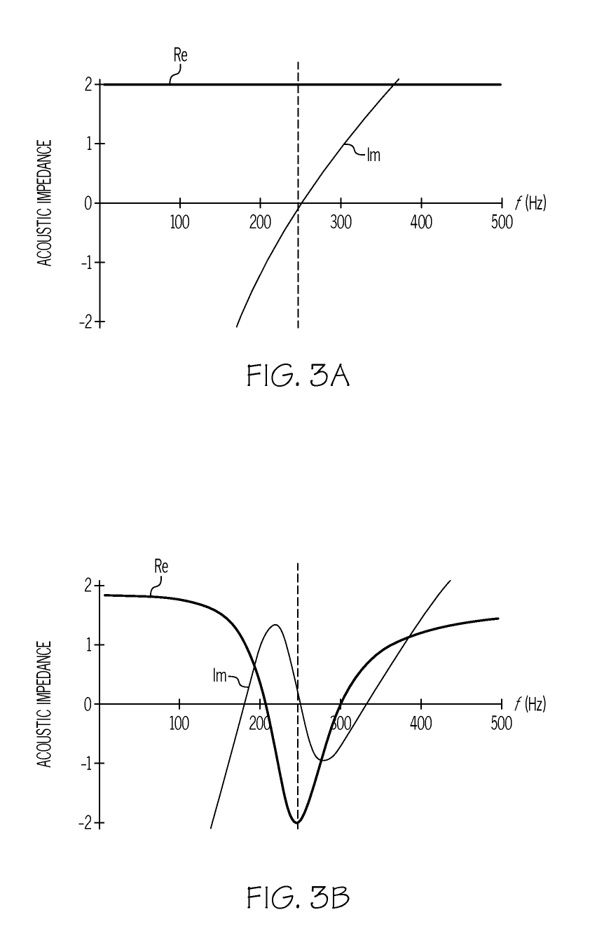

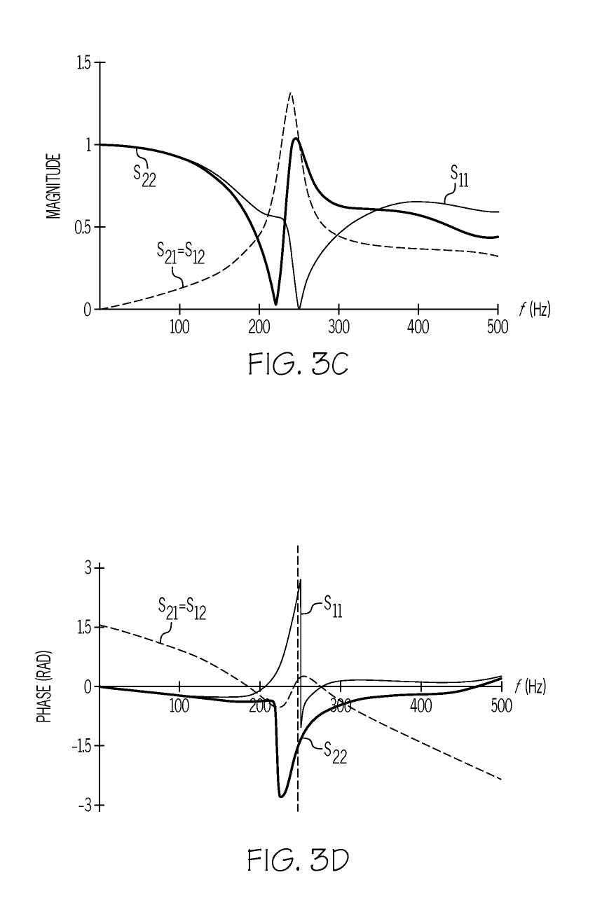

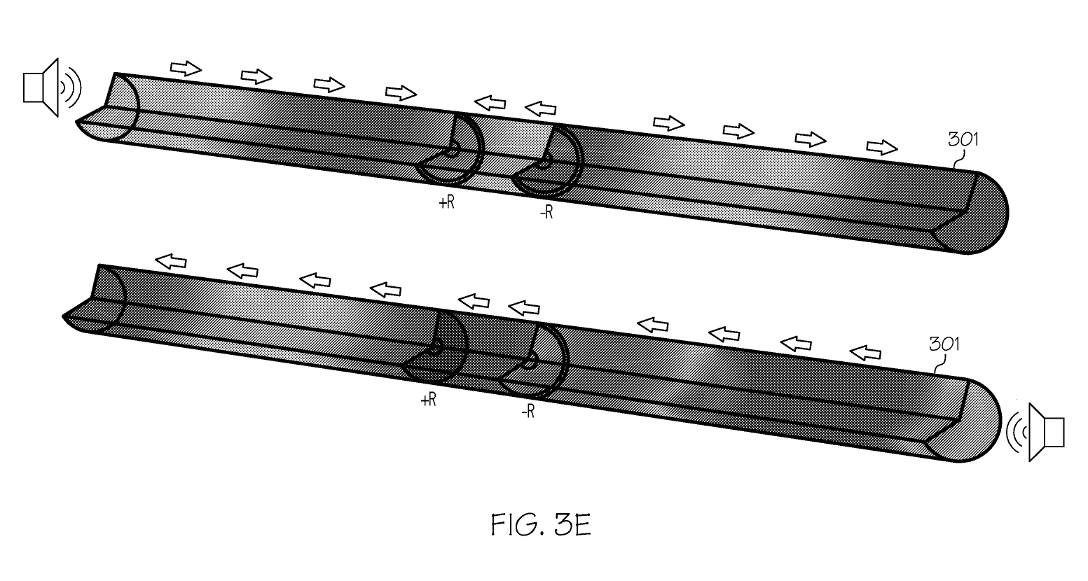

Referring back to FIGS. 1A-1B and 2A-2C, the normalized acoustic impedance of the loaded loudspeaker at port 1 is shown in FIG. 3A as a function of frequency and the normalized acoustic impedance of the loaded loudspeaker at port 2 is shown in FIG. 3B in accordance with an embodiment of the present invention. Referring to FIGS. 3A and 3B, FIGS. 3A and 3B illustrate that the exceptional point condition r=2 for unidirectional invisibility is achieved at fᵣ=250 Hz. The acoustic impedance of the first loudspeaker is exactly twice the line impedance, with no imaginary part, and the one at port 2 is the opposite, satisfying the condition r=2 for unidirectional invisibility. The dispersion of the −R loudspeaker is tailored by a non-Foster circuit that ensures stability, by carefully positioning zeros and poles of its electrical load in the complex plane. The separating distance x=sin⁻¹(1/4) has been chosen to ensure unitary reflection at port 2, consistent with Equation (3).

The S-parameters of this PT acoustic device, based on the theory presented herein, are shown in FIGS. 3C and 3D as a function of frequency. FIG. 3C illustrates the magnitude of the scatting parameters as a function of frequency in accordance with an embodiment of the present invention. FIG. 3D illustrates the phase of the scatting parameters as a function of frequency in accordance with an embodiment of the present invention. At fᵣ=250 Hz (vertical dashed line), the system is indeed unidirectionally invisible, with S₁₁=0, |S₂₂|=|S₂₁| 1, and it features the aforementioned anomalous phase advance at the transmission side. It is noted that the bandwidth of operation, which is relatively narrow here, may be increased by engineering the dispersion of the electrical loads around the frequency of operation, with a more complex circuit design. Properly tailored non-Foster circuits have been recently envisioned for broadband metamaterial operation.

To validate this unusual scattering response and gain further physical insights, full-wave simulations of the PT-symmetric acoustic cell in FIGS. 1A-1B were performed using COMSOL Multiphysics®, carefully modeling the acoustic inclusions by coupling acoustic and electrical circuit modules. The agreement between analytical and full-wave simulation results is excellent. FIG. 3E illustrates the acoustic pressure distribution in the device (snapshot in time) when excited at f=250 Hz by a wave incident from ports 1 (top) and 2 (bottom) in accordance with an embodiment of the present invention. From port 1, the incident wave is transmitted through the structure with the expected phase advance, no attenuation and zero reflection. From port 2, the wave is transmitted with same amplitude and phase, consistent with reciprocity, but an additional strong reflection arises at this port, associated with a large standing wave ratio.

The direction of average power flow in the system is also plotted, represented by the arrows 301 in FIG. 3E. Quite interestingly, the backward phase flow between the two loudspeakers, which is associated to the predicted phase advance, is sustained by a negative power flow, fed by the active inclusion, a unique feature of this PT negative-index metamaterial cell. At the sensing loudspeaker, the incident signal and the wave fed by the active inclusion add up in phase, and they are both completely absorbed by the passive loudspeaker, which forms the acoustic equivalent of a coherent perfect absorber, or a time-reversed lasing system, capable of absorbing all the incident power, as well as the power traveling backward from the active loudspeaker, without reflections. The power absorbed by the loudspeaker is then exactly twice the incident power, in total contrast with passively cloaked sensors which typically absorb a minimal amount of the incident signal. The right loudspeaker, on the contrary, is the acoustic equivalent of a coherent laser, which emits a signal perfectly synchronized in phase and amplitude with the impinging signal. While the backward portion of the emitted signal feeds the passive loudspeaker, the forward portion is responsible for eliminating the shadow, making the PT metamaterial cell fully invisible. The perfect synchronization between the impinging signal and the active loudspeaker takes place in free-space through airborne sound waves.

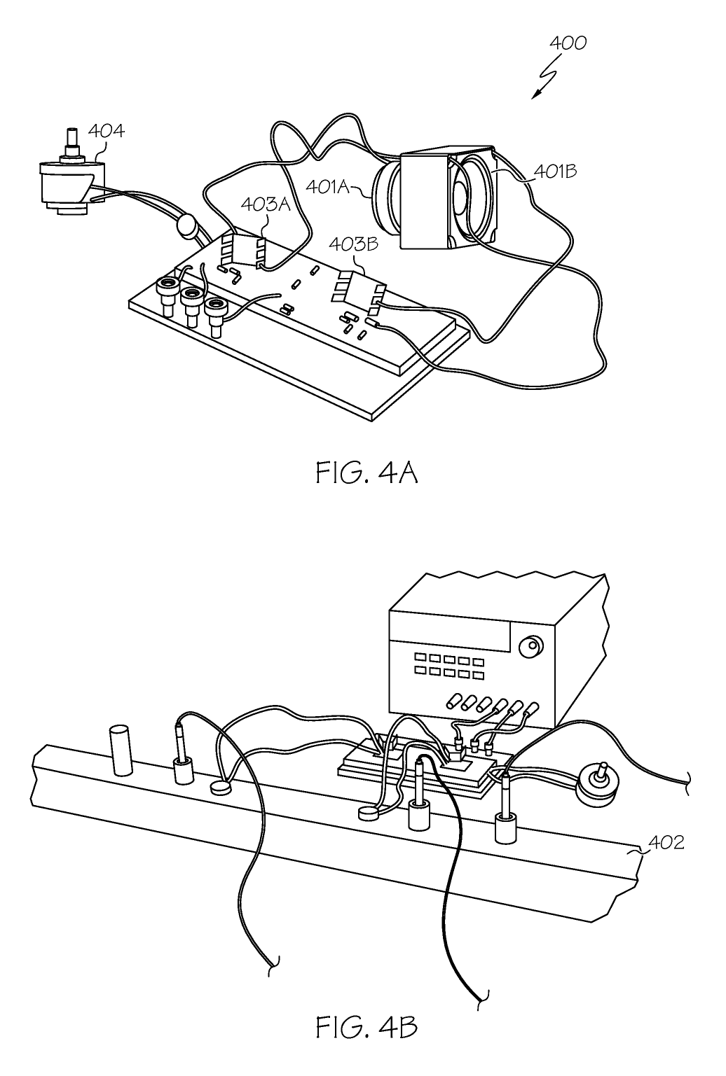

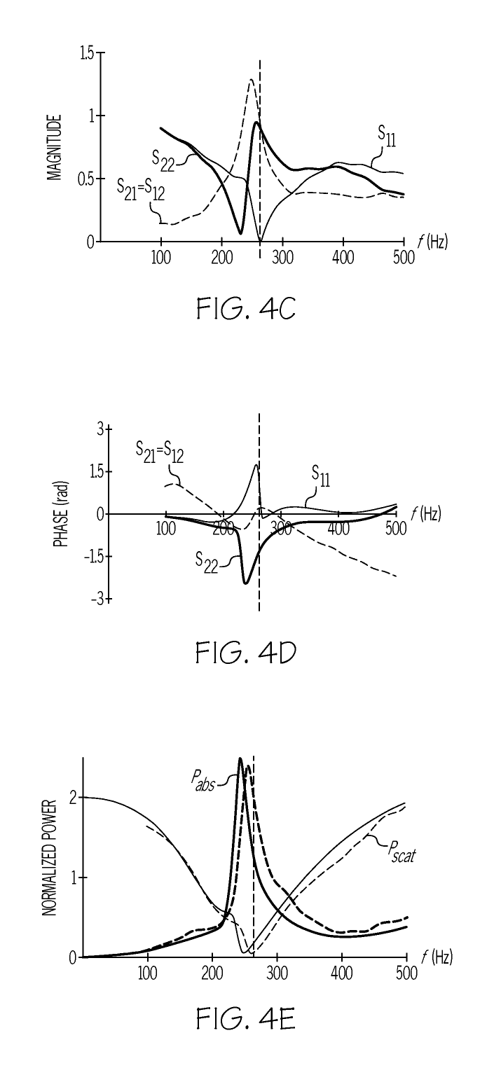

An experimental validation of the unidirectional invisible acoustic sensor will now be discussed. A picture of the fabricated PT acoustic device 400 is shown in FIG. 4A, showing the two loudspeakers 401A-401B separated by a portion of square acoustic waveguide 402 (FIG. 4B). In particular, FIG. 4A illustrates a fabricated PT acoustic device 400 showing the two loaded loudspeakers 401A-401B connected to non-Foster electrical circuits 403A-403B, respectively, in accordance with an embodiment of the present invention. A potentiometer 404 is used to measure the voltage. The non-Foster electrical circuits 403A-403B used to load loudspeakers 401A-401B, respectively, are implemented on a prototyping board with off-the-shelf electrical components, which can be manually tuned to ensure that the device is set to r=2 at the design frequency. PT acoustic system 400 is placed between two waveguides 402, as shown in FIG. 4B in accordance with an embodiment of the present invention, and its scattering parameters are measured using a calibration procedure described further below. The measured scattering parameters are shown in FIG. 4C (magnitude) and FIG. 4D (phase) in accordance with an embodiment of the present invention, in excellent agreement with the theoretical predictions of FIGS. 3A-3E. The fabricated device is indeed unidirectionally invisible at the design frequency (vertical dashed line), with a negative phase advance e for the transmitted signal, as theoretically predicted.

FIG. 4E compares the power absorbed by the passive loudspeaker to the total power scattered by the device, measured in the resistive circuit, in accordance with an embodiment of the present invention. Both quantities are normalized to the incident power. The experimentally measured curves (dashed lines) are in excellent agreement with the analytical predictions (solid lines). Quite remarkably, the scattered power is extremely low around the design frequency, while the absorbed power at the passive loudspeaker is twice the incident power, as predicted by our theoretical model. This proves the unique non-invasive nature of the fabricated sensing system, which can fully absorb the impinging signal, as well as its exact replica produced by the active portion of the sensor, while at the same time being almost invisible.

A brief discussion regarding the acoustic impedance of the loudspeaker is now deemed appropriate. The acoustic impedance of a loudspeaker is defined as the ratio between the pressure difference ΔP on both sides of the membrane and the volumetric flow Q=VS_{d}, where V is the velocity of the membrane and S_{d} the equivalent surface of the diaphragm. The geometry is assumed to be one-dimensional. To calculate this quantity, the equation for the time-harmonic dynamics of the moving mass, projected along the loudspeaker axis \vec{z}, is the following:

$${M}_{ms} j ω V = - Δ {PS}_{d} - \frac{1}{j ω {C}_{ms}} V - {R}_{ms} V + \vec{z} \cdot {\int }_{1}^{2} {I}_{12} d \vec{l} \times \vec{B} . \qquad ( 4 )$$

where Mₘₛ is the mass of the moving parts, Cₘₛ is the spring constant, also called the mechanical compliance, Rₘₛ is the damping constant, \vec{B} is the constant magnetic flux density on the voice coil, and I₁₂ is the electric current flowing in the voice coil from lead 1 to lead 2. Secondly, the electric equation for the current in the voice coil of impedance Zₑ=Rₑ+jωLₑ, where Rₑ and Lₑ are the electric resistance and inductance, respectively, is the following:

$${Φ}_{1} - {Φ}_{2} = {Z}_{e} {I}_{12} {\int }_{1}^{2} \vec{V} - \vec{B} . \qquad ( 5 )$$

In Equation (5), the potential difference Φ₁−Φ₂ is the voltage applied at the leads of the loudspeaker. In the case of loaded loudspeakers, however, this quantity is linked to the voice coil current via the load impedance Z_{L}, Φ₁−Φ₂=Z_{L}I₁₂. Because I₁₂ and \vec{B} are constant along the voice coil of total length L, one can further simplify the Laplace force integral in Equation (4) and the electromotive force integral in Equation (5) by introducing the transducer force factor Bₗ=BL·, and after some algebra to eliminate the variable I₁₂, one gets

$$Δ {PS}_{\overline{d}} = ( {Z}_{ms} + \frac{{B}_{l}^{2}}{{Z}_{e} + {Z}_{L}} ) V , \qquad ( 6 )$$

where Zₘₛ=Rₘₛ jωMₘₛ 1/jωcₘₛ is the mechanical impedance of the loudspeaker. The acoustic impedance, normalized by the line impedance of the waveguide Z₀ is therefore

$${Z}_{ac} = \frac{1}{{S}_{d}^{2} {Z}_{0}} [ {Z}_{ms} \frac{{B}_{l}^{2}}{{Z}_{e} + {Z}_{L}} ] . \qquad ( 7 )$$

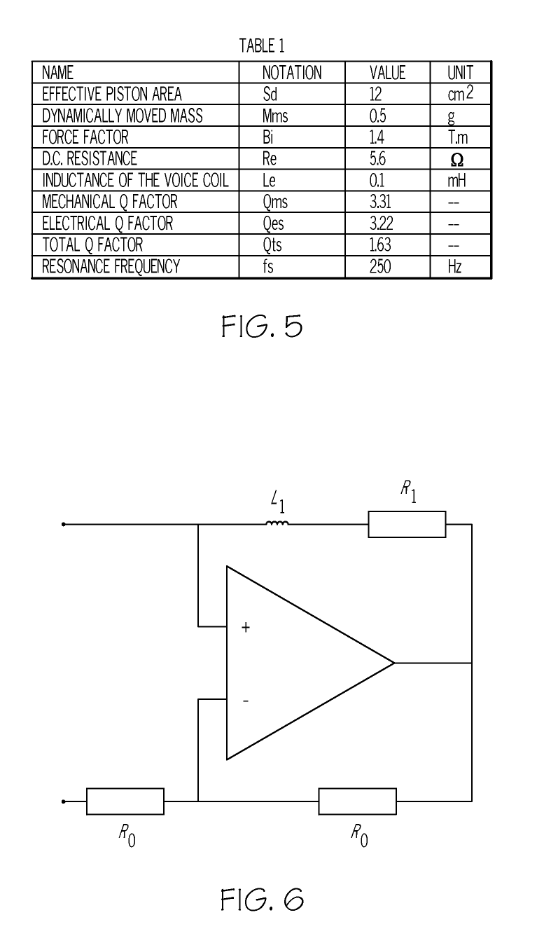

In one embodiment, the loudspeakers employed are two Visaton FRWS 5-8 Ω, 5″ in size, which resonate at 250 Hz. FIG. 5 is a table (Table 1) that lists the mechanical and electrical properties given by the manufacturer, also known as Thiele and Small parameters, in accordance with an embodiment of the present invention. The remaining quantities cₘₛ and Rₘₛ can be calculated from these parameters, using Cₘₛ=1/(ωₛ²Mₘₛ) and Rₘₛ=ωₛMₘₛ/Qₘₛ, with ωₛ=2πfₛ. The line impedance Z₀=ρ₀c₀/S₀ is calculated based on the waveguide cross-section and measured acoustic conditions in the laboratory, using ρ₀=1.1912 kg/m³, c₀=346.25 m/s, and S₀=19.8 cm².

In one embodiment, the design frequency was selected to be equal to the resonance frequency of the loudspeaker fᵣ=250 Hz. This slightly simplifies the design by canceling the reactive part of the mechanical impedance of the loudspeaker. The electrical loads are designed to provide a normalized acoustic impedance of ±2 at this frequency, while ensuring stability of the acoustic system. To ensure stability, the poles ωₚ of the acoustic admittance −Y_{ac}=1/Z_{ac}=−VS_{d}²Z₀/P are systematically placed so that their imaginary part be positive, within reasonable margins. The design procedure is discussed further below.

With respect to the design of the +R element, to fulfill the unidirectional invisibility condition, the passive +R element has Z_{ac}=2 at the design frequency. Plugging this value in Equation (7) and solving for Z_{L}, one gets the value that the electrical load must take at this particular frequency:

$${Z}_{L} = - {R}_{e} + \frac{{B}_{l}^{2} {C}_{ms} {S}_{0} {ω}_{s}}{2 {c}_{0} {C}_{ms} {ρ}_{0} {S}_{d}^{2} {ω}_{s} - {S}_{0} {C}_{ms} {ω}_{s} {R}_{ms}} - i {L}_{e} {ω}_{s} . \qquad ( 8 )$$

Equation (8), evaluated for the particular loudspeaker used in the present invention using the parameters of Table 1 (FIG. 5), suggests the use of a negative resistor −R₁ in series with a negative inductor −L₁. By applying the Routh criterion to the denominator of the acoustic admittance Y_{ac}, it is straightforward to show that such a RL loaded system is stable as long as R₁<Rₑ and L₁<Lₑ. For the value of R₁ required here, the first inequality would hold, however, the required value for the inductance sets the system on the verge of instability. To avoid this issue, L₁=0.95Lₑ. Such an approximation on the imaginary part of the required electrical impedance (Equation (8)) is very good, as the slope of the imaginary part at ωₛ, ∂Z_{L}/∂ω=Lₑ is small, and the inductive part of the circuit could even be completely dropped without altering significantly the synthesized acoustic impedance. The final electrical design, with typical negative impedance converter topology based on an operational amplifier, is shown in FIG. 6. FIG. 6 illustrates the electrical load for the +R loudspeaker in accordance with an embodiment of the present invention.

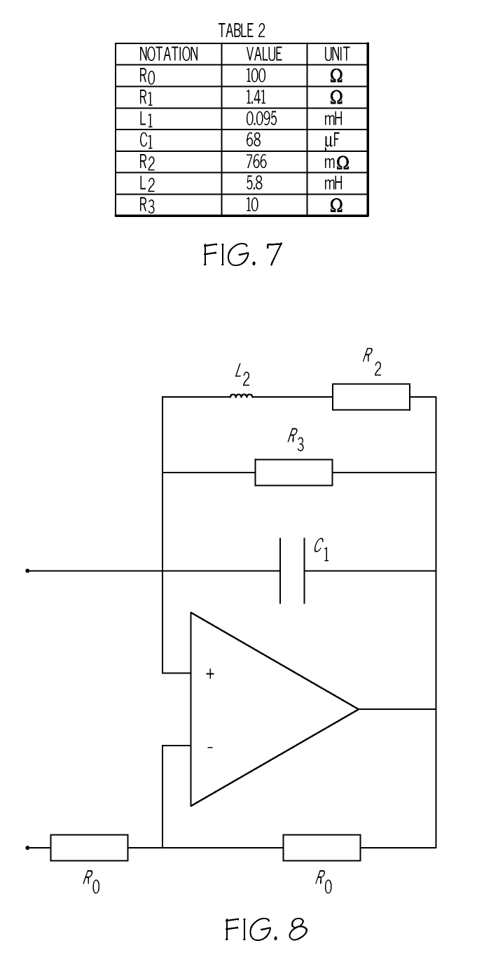

The values of the electrical components are summarized in Table 2 as shown in FIG. 7. FIG. 7 is a table (Table 2) of the values of the electrical components used in the electrical loads in accordance with an embodiment of the present invention. It is noted that the electrical circuit is active, although the acoustic impedance to be synthesized is passive. This is because the chosen loudspeaker is intrinsically too lossy, and the electrical circuit has to compensate for a part of these losses to fulfill the condition Z_{ac}=2. By choosing another loudspeaker, it may happen that only a purely positive resistance would be sufficient, as evident looking at (Equation (8)).

With respect to the design of the −R element, the starting point is to calculate the required electrical impedance at the design frequency to yield Z=2. The real part is the following:

$${Z}_{L}^{2} = - {R}_{e} + \frac{{B}_{l}^{2} {C}_{ms}^{2} ( {R}_{ms} + 2 {S}_{d}^{2} {Z}_{0} ) {ω}_{s}^{2}}{1 + {C}_{ms} {ω}_{s}^{2} ( {C}_{ms} ( {R}_{ms} + 2 {S}_{d}^{2} {Z}_{0} ) - {M}_{ms} )} = - 9.14 Ω , \qquad ( 9 )$$

and the imaginary part is the following:

Z_{i/L}=−LₑωₛΩ0.16. (10)

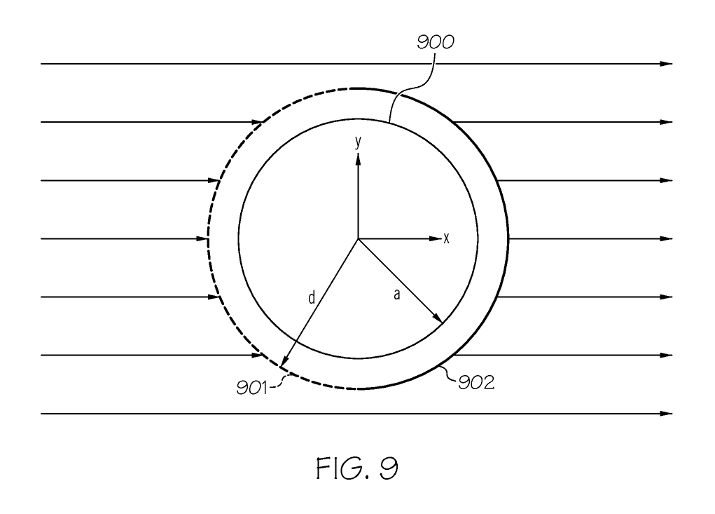

The −R element cannot be synthesized with a negative RL circuit because the required value for the resistor exceeds Rₑ and would lead to an unstable acoustic admittance. This means the dispersion of the load has to be tailored to reach the value (Equation (9)) and (Equation (10)) at fₛ, and at the same time be stable. For instance, one can use the following dispersion for the electrical load,

$${Z}_{L} = \frac{As + B}{{s}^{2} + 2 α s + {Ω}^{2}} , \qquad ( 11 )$$

where s=jω, and A, B, α and Ω are positive coefficients. Without the minus sign, Equation (11) represents a stable electrical impedance that can be realized using only passive components, by plugging in parallel 3 loads: a capacitive branch with capacitance C₁=1/A, a series RL branch with a resistance of R₂=B/(Ω²B²/A²−2αB/A) and an inductance L₂=A/(Ω²+B²/A²2αB/A) and a resistive branch with resistance R₂=A²/(2αAB). In Equation (11), the minus sign is added because at fₛ, the targeted impedance value has negative real and imaginary parts [see Equations (9) and (10)]. This will require the use of a negative impedance converter in front of the previously discussed parallel load, turning it into a non-Foster element, represented in FIG. 8. FIG. 8 illustrates the electrical load for the −R loudspeaker in accordance with an embodiment of the present invention.

Next, we look for A and B such that the real and imaginary parts of Z_{L} in (Equation (11)) match the required values (Equation (9)) and (Equation (10)). We obtain

$$\begin{matrix}B = 2 {Z}_{L}^{i} α {ω}_{s} {Z}_{L}^{r} ( {ω}_{s}^{2} {+}^{2} ) , and & ( 12 ) \\ A = {Z}_{L}^{i} ( {ω}_{s} \frac{{Ω}^{2}}{{ω}_{s}} ) - 2 {Z}_{L}^{r} α . & ( 13 )\end{matrix}$$

The remaining parameters a and SI need to be determined so that the impedance is stable. To do so, substitutions (Equation (12) and Equation (13)) are made in (Equation (11)), and the acoustic admittance 1/Z_{ac} is calculated using Equation (7). After a lengthy but straightforward calculation, a rational fraction in s is obtained, whose denominator is a polynomial of order 5. By applying Routh-Hurwitz criterion on the denominator, a range of values for α and Ω is numerically determined that ensures stability of the acoustic system. In particular, the values α=800 and Ω=1650 rad/s provide stability with good margins. The required values for the electrical components are summarized in Table 2 of FIG. 7. Reasonable values were obtained, realizable with off-the-shelf components.

Returning to FIGS. 4A-4E, beyond proving the possibility of realizing an ideal invisible sensor, the results of FIGS. 4C and 4D constitute the first experimental evidence of unidirectional transparency in a truly PT-symmetric metamaterial device, in contrast to previous experiments of unidirectionally reflecting structures with asymmetric loss distribution but without gain. While the above description has focused on a unidirectional sensing system, the same PT-symmetric topology can be readily used to form an omnidirectional invisible sensor, if the acoustic distance is chosen to be a multiple of π. The results discussed herein also introduce the concept of pairing coherent lasing and coherent absorption to realize stable and efficient invisible sensors, not only for acoustic waves, but also for electromagnetic waves and light.

More generally, the principles of the present invention discussed herein opens new directions for loss compensation in metamaterials, as the observed phenomena are totally loss-immune and fully linear. In this context, a new exciting possibility to realize PT-based, fully lossless negative-index propagation that does not rely on resonant inclusions or bulk media has been presented. In the experimental setup of the present invention, the wave is normally incident on a single PT cell, however, the principles of the present invention are to include 2D or 3D arrays of such inclusions that may negatively refract or focus acoustic waves. This may find promising applications in loss-compensated sound focusing, loss-immune phase compensation, non-invasive subwavelength acoustic imaging and sensing.

In the following, another application of parity-time symmetric metamaterials and metasurfaces for ideal unidirectional invisibility is discussed. Cloaking an object and making it undetectable to an impinging wave has attracted tremendous attention in the last decade: the advent of metamaterials and the emergence of concepts, such as transformation-optics and scattering cancellation techniques, have heated up the ever-lasting interest in camouflaging and invisibility. Such approaches aim at cancelling an object's scattering cross-section for any illumination direction, often at the expense of structural complexity and inherent limitations on bandwidth, electrical size of the object to be cloaked and overall scattering reduction. Nevertheless, there are many practical situations when the direction of an impinging wave is known and an object needs to be made invisible only from this particular direction. This fact has recently inspired the design of unidirectional cloaks, i.e., cloaks that are able to suppress the scattering for a particular incidence direction, relaxing the inherent constraints of full cloaking techniques. For example, based on the carpet-cloaking concept, a unidirectional cloak has been presented with simplified material parameters, although still relying on anisotropic electric and magnetic materials. Using a different principle, active cloaks have been reported based on the equivalence principle, in which the cloaked object is coated with antenna arrays supporting suitable electric and magnetic sources that can cancel the scattered field for a particular incident wave.

In addition to opening a path towards simplifying cloaking designs, unidirectional invisibility has recently been studied as a unique property of parity-time (PT) symmetric structures. PT symmetry is the invariance of a system under parity and time-reversal operations and has recently attracted significant attention because it can lead, quite unexpectedly, to non-Hermitian Hamiltonians with real eigenvalues. Although the relevance of PT symmetry in quantum mechanics is still disputed, it is not the case for optical PT symmetry, which has already been reported in structures with balanced amounts of gain and loss, and is accompanied by unique phenomena, such as laser-absorber modes and enhanced non-reciprocity. Unidirectional invisibility occurs in one-dimensional (1D) PT-symmetric lattices, which exhibit unitary transmission for either propagation direction, zero reflection for one propagation direction and non-zero reflection for the other one. The concept of PT-symmetric unidirectional invisibility was recently extended to two-dimensional geometries by applying coordinate transformations to a PT-symmetric cylindrical region. However, the invisibility achieved using this concept is imperfect and it requires the use of anisotropic electric and magnetic materials with loss and gain, which may be even more challenging to realize than the lossless anisotropic materials involved in conventional transformation-optics methods.

As discussed herein, ideal unidirectional invisibility may be obtained, independent of the size of an object, using PT-symmetric metasurfaces. Inspired by the mantle-cloaking technique, which uses a metasurface to suppress a portion of the scattering of a given object, it is proposed to surround a perfectly conducting (PEC) cylinder with a PT-symmetric admittance surface, designed so that there is identically zero scattering for monochromatic waves propagating along the +x direction as discussed below in connection with FIG. 9.

Conventional mantle cloaking is based on passive surfaces, although an extension to active inclusions was recently introduced. This technique was originally aimed at cancelling the first few scattering harmonics of the object to be cloaked by suitably inducing conduction currents on the admittance surface. Since the number of scattering harmonics determining the scattering properties of an object grow exponentially with its electrical size, there is a fundamental limitation on the maximum size of the objects that can be efficiently cloaked with this technique. On the contrary, as discussed herein, by allowing the mantle to have balanced loss and gain, it is possible to overcome the aforementioned size limitations and achieve full invisibility for objects of any size, with a recipe much simpler than transformation-optics cloaks. Such a technique is applied to circular and rhomboidal cylinders, and for a small separation between the mantle surface and the cylinder, the required admittance follows a simple sinusoidal or uniform profile, which is relatively easy to realize. Furthermore, similar to 1D PT-symmetric lattices, waves propagating in the −x direction, i.e., the direction opposite to the design direction, experience substantial scattering.

A naive but elegant way to obtain full invisibility with an ultrathin metasurface may consist in completely absorbing the incident power on one side of the structure (left-hand side in FIG. 9) and emitting the same amount of power, with the same angular pattern, from the other side (right-hand in FIG. 9). FIG. 9 illustrates a PEC cylinder 900 covered with a PT-symmetric surface in accordance with an embodiment of the present invention. The left and right portions of the surface (line 901 and line 902, respectively) have loss and gain, respectively. The lossy part is tailored to absorb all of the impinging power, whereas, the gain part emits the same amount of power.

Obviously, the absorbing and emitting portions of such a metasurface should have loss and gain, respectively. It is interesting that, if the object to be cloaked is PT-symmetric, as in the case of symmetric, lossless objects, and at the same time the impinging field is also PT-symmetric, as in the case of a plane-wave, then the required metasurface is also necessarily PT-symmetric. The PT-symmetry of the cloak is easy to prove by considering for simplicity the 2D circularly symmetric scenario of FIG. 9. If the object is covered with an admittance Yₛ(φ), which is assumed to be the one leading to unidirectional invisibility, application of a PT transformation results in a scenario where the object is covered with an admittance −Yₛ*(π−φ). Then, since in the case of unidirectional invisibility the only field outside the cloak is the incident plane wave and because plane waves are inherently PT symmetric, it is concluded that Yₛ*(π−φ) a also necessarily leads to unidirectional invisibility. If there is only one surface that can provide unidirectional invisibility, which will be proved to be the case in the following, then Yₛ(φ) and −Yₛ*(π−φ) are necessarily equal, showing that the cloaking surface indeed is PT-symmetric.

The surface admittance Yₛ(φ) can be calculated from the boundary condition Jₛ=YₛEₛ, where Eₛ and Jₛ is the electric field and current induced on the surface, respectively. The latter is given by Jₛ=\hat{r}×(H₊−H₋), where H₊ and H₋ is the magnetic field at the exterior and interior side of the surface, respectively. For ideal invisibility, the only field outside the surface is the incident one, E_{inc}=E₀e^{ikx}\hat{z}, yielding Eₛ=E₀e^{ikd cos φ}\hat{z} and H₊=−Y₀E₀e^{ikd cos φ}ŷ, where Y₀ is the wave admittance in free space. For the calculation of H₋, the exterior and interior fields are expanded in terms of cylindrical harmonics Jₙ(kr)e^{inφ} and Yₙ(kr)e^{inφ} as

$${E}_{ext} = {E}_{inc} \hat{z} {E}_{0} = {\sum }_{n = - ∞}^{∞} {i}^{n} {J}_{n} ( kr ) {e}^{i n ϕ} , \\ {E}_{int} = \hat{z} {E}_{0} {\sum }_{n = - ∞}^{∞} {i}^{n} [ {a}_{n} {J}_{n} ( kr ) + {b}_{n} {Y}_{n} ( kr ) ] {e}^{i n ϕ} . \qquad ( 14 )$$

Then, the corresponding magnetic fields are found by means of Faraday's law, H=∇×E/(iωμ₀), and the coefficients aₙ and bₙ are calculated by applying the continuity of the electric field on the admittance surface and the PEC cylinder. After some straightforward algebraic manipulations, we find

$${Y}_{s} = {iY}_{0} \frac{2}{π k d} {e}^{- i kd cos ϕ} {\sum }_{n = - ∞}^{∞} {i}^{n} \frac{{J}_{n} ( ka )}{{J}_{n} ( k d ) {Y}_{n} ( ka ) - {J}_{n} ( ka ) {Y}_{n} ( k d )} {e}^{i n ϕ} . \qquad ( 15 )$$

It can be easily verified that Yₛ(π−φ)=−Yₛ*(φ), hence the surface admittance is indeed PT-symmetric, as predicted. Equation (15) can be substantially simplified in the limiting case k(d−a)□1, i.e., for a thin spacer between the metasurface and the metallic cylinder. Taking the Taylor expansion of Yₛ with respect to d around d=a and keeping the terms up to the zeroth order, yields

$$Re \{ {Y}_{s} \} \approx - {Y}_{0} cos ϕ , \\ Im \{ {Y}_{s} \} \approx - {Y}_{0} [ \frac{1}{k ( d - a )} - \frac{1}{2 ka} ] . \qquad ( 16 )$$

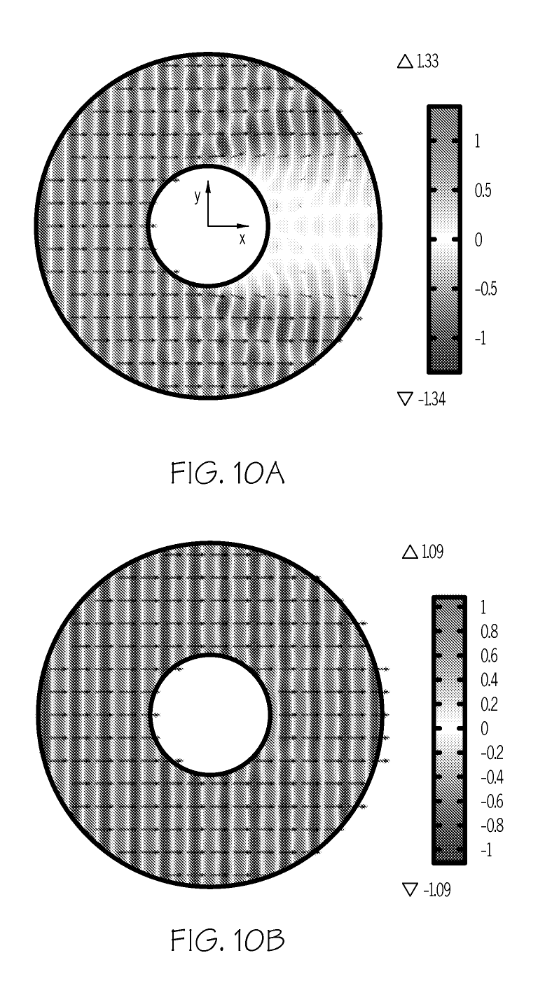

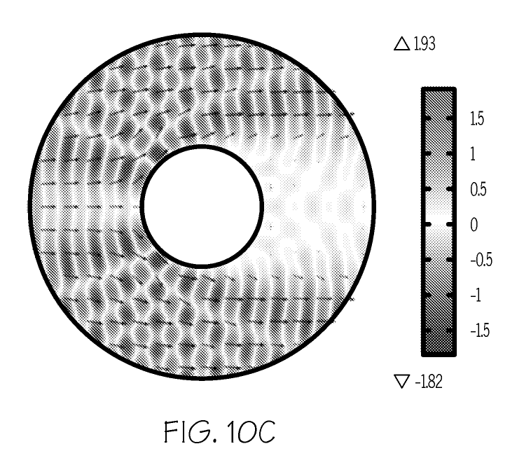

Equation (16) has a simple physical interpretation in terms of geometrical optics. For |φ|>π/2 (lossy side of the mantle surface), Re{Yₛ} is equal to the characteristic admittance of a +x-propagating plane wave on any of the cylinder's tangential planes. This is the necessary condition for ideal impedance matching between the mantle surface and the incident wave in a ray-picture approximation, and therefore allows for full absorption of the incident power. This is visible in FIG. 10A, showing the electric field and power distribution for a half-cloaked cylinder from its left-hand (lossy) side in accordance with an embodiment of the present invention: all the incident power is absorbed by the impedance surface, resulting in zero back-scattering, but a large shadow is created at the right-hand side of the cylinder, making it detectable from the forward direction. It is noted that in addition to the condition for the real part of Yₛ, impedance matching requires cancelation of the PEC cylinder's reactance. This is achieved via the imaginary part of Yₛ, as given in Equation (16). Indeed, it can be easily shown that the term −Y₀/[k(d−a)] is opposite to the input susceptance of a shorted transmission line with length d−a, while the term Y₀/(2ka) is related to the finite curvature of the cylinder.

On the other hand, for |φ|<π/2 (gain side of the surface), Re{Yₛ} is opposite to the characteristic admittance of an x-propagating plane wave on any of the cylinder's tangential planes. This condition is similar to a semi-infinite transmission line terminated with an impedance opposite to the line's characteristic impedance. In this 1D transmission line scenario, such a termination leads to an infinite reflection coefficient, and, as a result, it allows power emission from the gain element without any external excitation. On the other hand, self-sustained emission is impossible in the case of the coated cylinder, due to the finite area covered by the gain medium. Although the reflection coefficient is locally infinite, the infinitesimal amount of power impinging on an infinitesimal area of the coated cylinder results in a finite scattered field, which, when integrated all over the finite area of the object, yields a finite value for the total scattered power. Nevertheless, a very weak signal with the appropriate amplitude and phase, as the one leaking in the shadow region of FIG. 10A from the top and bottom of the cylinder, can trigger emission of a +x-propagating plane wave, identical to the incident one, thus cancelling the shadow effect created by the lossy part of the surface. This is visible in FIG. 10B, depicting the electric field and the power distribution for a fully-cloaked cylinder in accordance with an embodiment of the present invention: the incident plane wave absorbed at the left-hand side of the cylinder is fully restored at its right-hand side, making the object fully undetectable, even in the forward direction. For comparison, FIG. 10C presents the electric field and power distribution of a bare cylinder, where one can see that without the cloaking metasurface the incident field is significantly distorted, in accordance with an embodiment of the present invention. Furthermore, it is noted that the large electrical size of the cylinder (diameter of four wavelengths) and the very small distance between the impedance surface and the cylinder (0.01 wavelengths), which demonstrate the unique potential of the proposed approach to realize extremely thin cloaks for electrically large objects, in total contrast with conventional passive cloaking techniques.

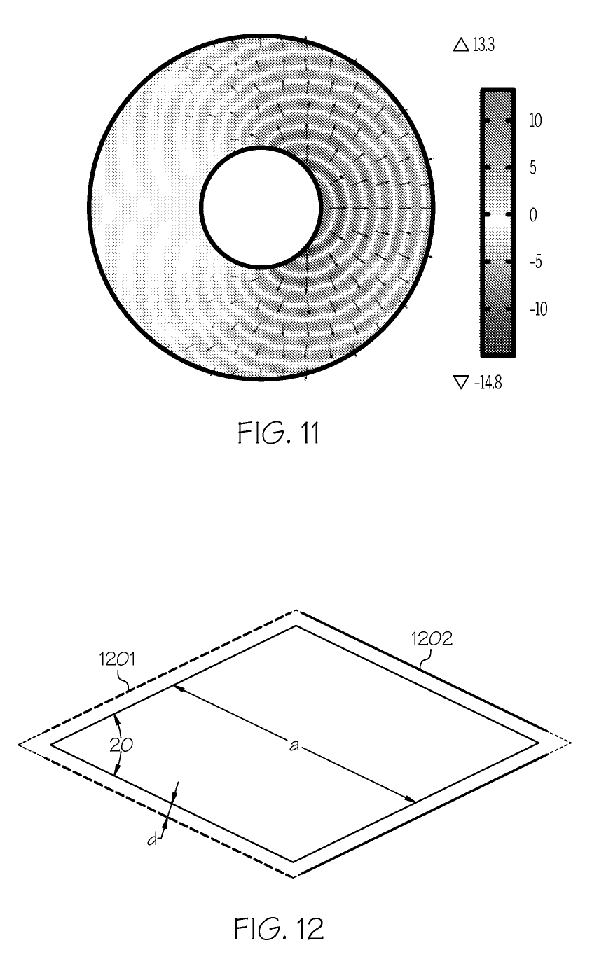

Similarly to its 1D counter-parts, the 2D PT-symmetric cloak presented herein exhibits strong scattering asymmetry for opposite incidence directions: although scattering is almost zero for incidence from the +x direction, it becomes very large for incidence from the opposite one. As recently demonstrated, such an asymmetry cannot only be produced by geometrical asymmetries, but it inherently requires loss and/or gain, as in PT-symmetric structures. FIG. 11 presents the electric field and power distribution in the case of a fully-cloaked cylinder for incidence from the −x direction in accordance with an embodiment of the present invention: the incident wave experiences significant scattering, with the magnitude of the scattered field being more than ten times larger than the corresponding of the incident field, which was taken here equal to one. The much larger amplitude of the scattered wave than the incident one essentially means that most of the scattered power originates from the gain medium. This strong scattering effect is the result of the opposite matching between the right-hand half-part of the impedance surface and x-propagating plane waves, leading to a locally infinite reflection coefficient, as previously discussed. In one embodiment, FIG. 11 illustrates the electric filed and power distribution for a PT-symmetric cloaked circular cylinder with radius a=2λ. The thickness of the spacer between the cloaking metasurface and the cylinder is d−a=0.01λ. The structure is illuminated from its right-hand size.

Illumination from the −x direction is a case where instability can potentially exist, due to the locally infinite reflection coefficient along the entire gain part of the impedance surface. An infinite planar surface with such a property would exhibit a globally infinite reflection coefficient and therefore it would be unstable. However, in the case of the circular cylinder, the finite area covered by the gain medium and the curvature of the surface, which disperses the scattered power all over the space, result in a finite scattered field for a finite incident power density, showing that multidimensional PT-symmetric cloaking can in principle be stable. In fact, the above ray-approximation analysis demonstrates the absence of scattering poles on the real axis of the complex frequency plane, related to oscillating waves, while a full stability analysis should also investigate the existence of poles in the top half of the complex frequency plane, related to exponentially growing waves. Fully-stable PT-symmetric structures were designed and experimentally demonstrated by properly selecting the poles and zeros of the gain elements involved. It is believed that by following a similar approach, it is also possible to design fully stable multidimensional PT-symmetric structures, like the ones analyzed herein.

Despite the apparent simplicity of Equation (16), a non-uniform impedance profile may be practically challenging to achieve. Furthermore, increasing the radius of the cylinder requires using more terms in the Taylor expansion of Equation (15), therefore further increasing complexity. The last fact, which may seem counter-intuitive considering that the approximation of a thin spacer, under which Equation (16) was derived, improves as a increases, is a result of the large sensitivity of the gain part of the metasurface on the amplitude and phase of the cylinder's shadow field. As explained before, such a field triggers the emission of a +x-propagating wave in the right-hand side of the object and is therefore responsible for the restoration of the incident wave past the object. For these reasons, it would be highly desirable to remove spatial non-uniformity and design a metasurface that consists of only two distinct uniform regions, one with loss and another one with gain. This is possible if the object to be cloaked is confined in a rhomboidal PEC shell, as in FIG. 12, exploiting the fact that the angle between an x-propagating plane wave and the normal direction to the shell's surface is the same all around the shell. This condition is apparently not satisfied at the corners of the rhombus, which slightly perturb the amplitude and the phase of the shadow field and subsequently introduce some scattering. However, as it will become apparent later, such an effect is minimal even for cylinders with very large electrical size. FIG. 12 illustrates a PEC rhomboidal cylinder covered with a PT-symmetric metasurface in the form of a rhomboidal cylinder with the same opening angle in accordance with an embodiment of the present invention. As in the case of the circular cylinder, the left and right portions 1201, 1202, respectively, of the metasurface have loss and gain, respectively, in order to absorb and emit plane waves impinging from the left. Cloaking is applied to the projection of the PEC rhombus on the outer rhombus, indicated with a dashed line.

A more detailed discussion regarding FIG. 12 is now deemed appropriate. Assume a rhombus with a side length a and an opening angle 2θ. Furthermore, assume that the cloaking surface is also a rhombus with the same opening angle and at a distance d from the object to be cloaked, as shown in FIG. 12. Then, the characteristic admittance of a TM x-propagating plane wave on any face of the rhombus is equal to Y₀ cos θ. Therefore, the real part of Yₛ should be selected as Re{Yₛ}=Y₀ cos θ and Re{Yₛ}=−Y₀ cos θ for the lossy and gain parts of the metasurface, respectively, so that the structure is impedance matched to x-propagating waves. On the other hand, Im{Yₛ} should cancel the reactance of the PEC rhombus as measured at the cloaking metasurface. This reactance reads iY₀ cos θ cot(kd cos θ) and is found from the expression iY_{c} cot(βl) for the input admittance of a shorted transmission line with length l, characteristic impedance Y_{c} and wavenumber β, after substituting d=l, Y_{c}=Y₀ cos θ and) β=k cos θ. Consequently, the reactive part of the admittance of the metasurface should be selected as Im{Yₛ}=−iY₀ cos θ cot(kd cos θ).

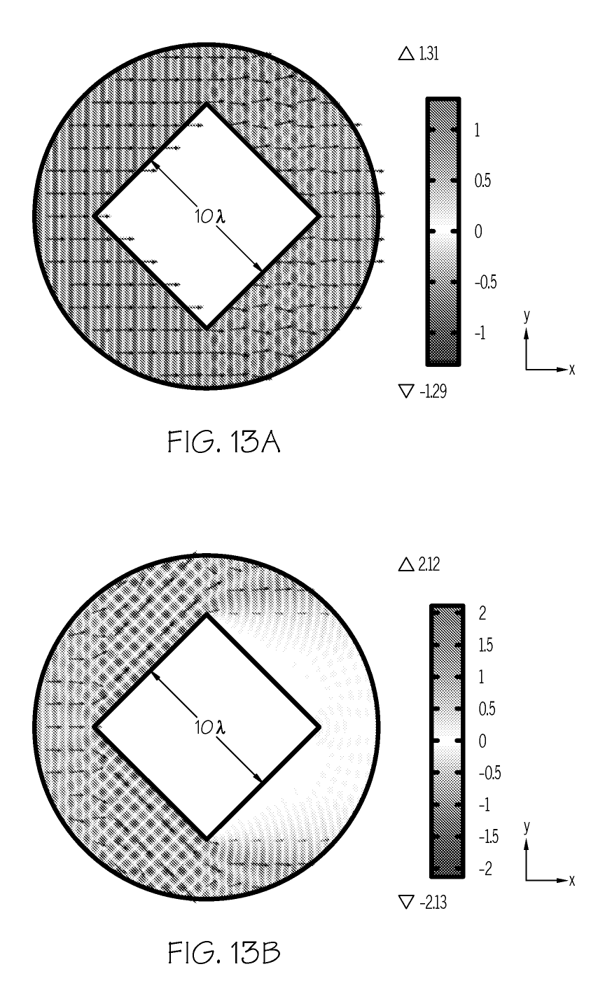

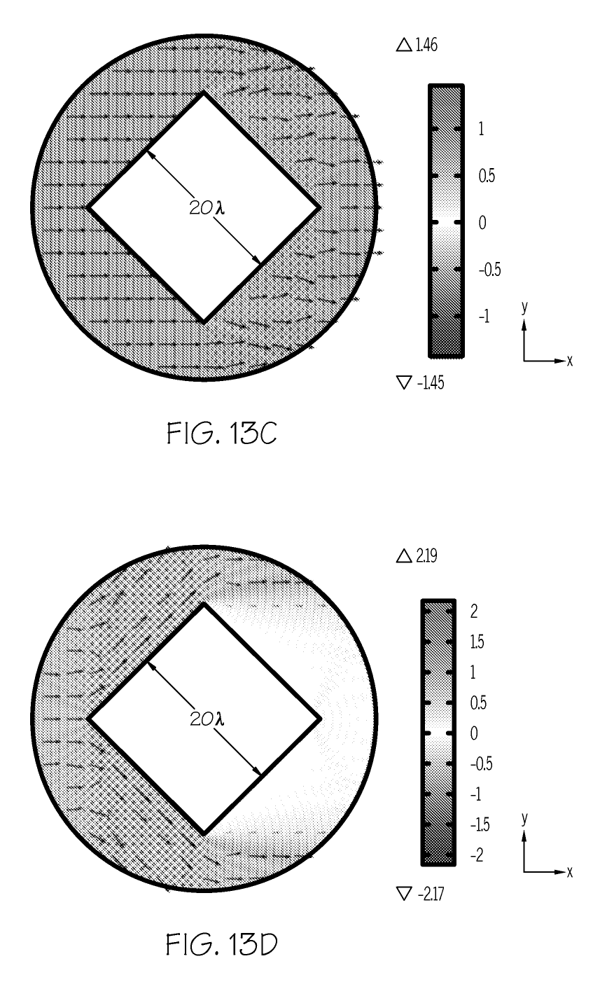

FIG. 13A presents the electric field and power distribution in the case of a PT-symmetric cloaked rhomboid with an opening of 90°, a=10λ and d=0.05λ in accordance with an embodiment of the present invention. FIG. 13B presents the electric field and power distribution in the case of a bare rhomboid with a=10λ in accordance with an embodiment of the present invention. FIG. 13C presents the electric field and power distribution in the case of a PT-symmetric cloaked rhomboid with a=10λ and d=0.05λ in accordance with an embodiment of the present invention. FIG. 13D presents the electric field and power distribution in the case of a bare rhomboid with a=20λ in accordance with an embodiment of the present invention. The opening angle is 90° for both cylinders (rhombuses with a=102 and a=20λ corresponding to cross sections of 14.1λ and 28.2λ) and d=0.05λ. Furthermore, the cloaking admittance is only applied along the projection of the interior rhombus on the exterior one, a configuration found to minimize scattering from the edges. The case of uncloaked cylinders (FIGS. 13B and 13D) is also presented for comparison. It is clear that PT-symmetric cloaking drastically reduces scattering even for rhomboids with very large electrical size, almost completely restoring the incident wave in front of the object. The slight distortion of the wave-fronts between the vertical axis of the object and its right corner is due to emission of y-directed plane waves by the gain part of the metasurface. Emission of such waves is possible because their impedance on the rhombus's faces is equal to Y₀ cos θ, and, therefore, they are locally associated with an infinite reflection coefficient along the gain part of the metasurface, likewise x-propagating plane waves. Ideally, the field in the shadow region of the object would only trigger a +x-propagating plane wave, thus perfectly restoring the incident wave. However, the discontinuity introduced by the rhombus's corners perturbs the amplitude and phase of the shadow field, resulting in undesired power emission along the y-direction. In a practical design, elimination of this effect could be accomplished by rounding the corners of the object in an optimized fashion.

The structures presented herein have a fundamental advantage in using PT-symmetric metasurfaces. The PT-symmetric metasurface automatically adapts the induced surface current distribution to the incident field, as if the structure presented an internal feedback mechanism that allows to unidirectionally cloak the object for any amplitude and phase of the impinging wave. A modulated signal may be sent through the obstacle without any distortion or scattering. The eigen-modal radiation sustained by the active part is fed by the passive portion of the metasurface, and the combination of the two provides a unique way of ideal unidirectional cloaking.

Hence, PT-symmetry can open exciting venues to cloak objects of arbitrary size. The coating surface can be tailored to absorb the impinging power on one side of the object and at the same time emit the required radiation from the other side. Similar to 1D PT-symmetric lattices, the structure presented here exhibits strong scattering asymmetry: for one propagation direction it is invisible, while for the opposite one it exhibits significant back-scattering. While this work has focused on 2D objects, similar principles can be straightforwardly extended to 3D. Furthermore, analogous concepts may be applied to objects of arbitrary, asymmetric shape and/or to impinging waves of arbitrary form. In this case, the required metasurface, while still retaining the balanced loss-gain features will not be PT-symmetric, compensating for the asymmetries in the object or in the excitation.

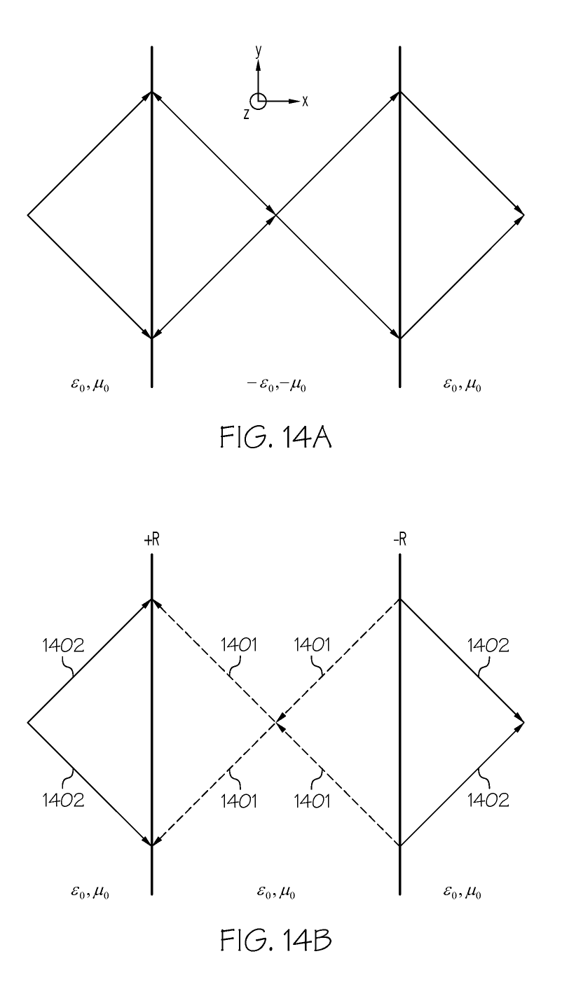

A brief discussion regarding negative refraction and planar focusing based on parity-time symmetric metasurfaces is now deemed appropriate. According to Snell's law of refraction, a consequence of the Huygens-Fermat principle, a beam of light hitting the interface between two homogeneous media refracts at an angle related to the ratio between the refractive indices of the two media. Because every known natural material has a positive index, refraction usually occurs in the same direction. Refraction in the negative direction requires one of the two media to have a negative index, a peculiarity that can be observed in artificial electromagnetic materials, or metamaterials, that are engineered to possess simultaneously negative values of the permittivity ε and permeability μ. Negative refraction allows us to manipulate electromagnetic waves in new ways, opening exciting venues in a variety of application fields, such as antenna technology, electromagnetic absorbers, phase compensation, subwavelength photolithography and planar focusing lenses. In particular, a negative bending of light is the key to realize a perfect lens, a planar device capable of focusing all the spatial Fourier components of a source, realizing a perfect image with, in principle, infinite resolution. FIG. 14A shows conventional negative refraction in a passive DNG medium for light rays emitted by a source placed on the left side of the slab in accordance with an embodiment of the present invention. The power flows away from the source and the phase velocity in the slab is backward.

The practical implementation of negative refraction using a bulk double-negative (DNG) metamaterial slab, however, has inherent challenges that severely hinder its applicability. The required electromagnetic properties are in fact typically obtained by exploiting the resonant response of subwavelength inclusions, whose dispersion is fundamentally associated with undesired material losses, a result of Kramers-Kronig relations, which hold for any linear, passive and causal medium. Loss, finite granularity, and non-ideal isotropy of metamaterials severely affect the ultimate resolution of these devices.

For these reasons, scientists have been looking for alternatives to the use of bulk metamaterials to bend light in the negative direction. It has been demonstrated that the same functionality of a bulk negative-index slab, and focusing of both propagating and evanescent waves, can be achieved by using a pair of identical phase conjugating surfaces. This concept can be implemented at microwaves using active non-linear wave mixing surfaces, and in optics with four-wave mixing using two highly nonlinear optical films. Phase conjugation on the two surfaces takes the role of the two interfaces of an ideal bulk metamaterial with negative index of refraction, and the ray picture of FIG. 14A still holds if one replaces the negative index slab with such a metasurface pair. For this to work, however, each metasurface is required to parametrically amplify the conjugate signals at a level much larger than the impinging signal, with stringent requirements on conversion efficiency that fundamentally limit the overall resolution of this system. Also in this case, inherent loss and imperfections can drastically limit these nonlinear effects in practical scenarios.

A new approach is discussed herein to achieve negative refraction and planar focusing. Rather than relying on conjugating the electromagnetic fields at the two planar interfaces, as in FIG. 14A, the anomalous scattering properties of parity-time (PT) symmetric systems is exploited. Scattering from PT-symmetric optical structures have been mainly studied for the possibility of inducing unidirectional invisibility. However, their potential to achieve loss-immune, metamaterial-free, and fully linear, negative refraction is demonstrated herein. In conventional planar focusing using a DNG slab (FIG. 14A) negative refraction requires a flip of the longitudinal component of the wave vector in the slab, essentially resulting in a phase velocity distribution consistent with PT-symmetry. It is heuristically conjectured, therefore, that negative refraction may occur in a PT-symmetric metasurface configuration, as represented in FIG. 14B. FIG. 14B illustrates negative refraction using PT-symmetric metasurfaces with real surface impedances +R and −R in accordance with an embodiment of the present invention. In this active scenario, both power flow and the phase velocity are directed from the active surface to the passive one, and negative refraction is obtained without the need for a bulk metamaterial. Here, two metasurfaces separated by a distance d in a vacuum are characterized by a PT-symmetric impedance distribution Z_{left}=−Z_{right}*, where * indicates conjugation. In this configuration an outside field distribution similar to FIG. 14A may be induced with similar backward phase flow between the surfaces, but also with a backward power distribution, flowing from the second surface to the first one, as represented by arrows 1401 of FIG. 14B. Arrows 1402 of FIG. 14B represent the forward phase flow. If the second surface is active, it may indeed sustain an outward Poynting vector distribution around it, while the first surface acts as a power sink. The simplest possible PT-symmetric metasurface pair that may support this functionality is a couple of metasurfaces with opposite resistivity, +R on the source side, and −R on the image side, as shown in FIG. 14B and assumed in the following analysis.

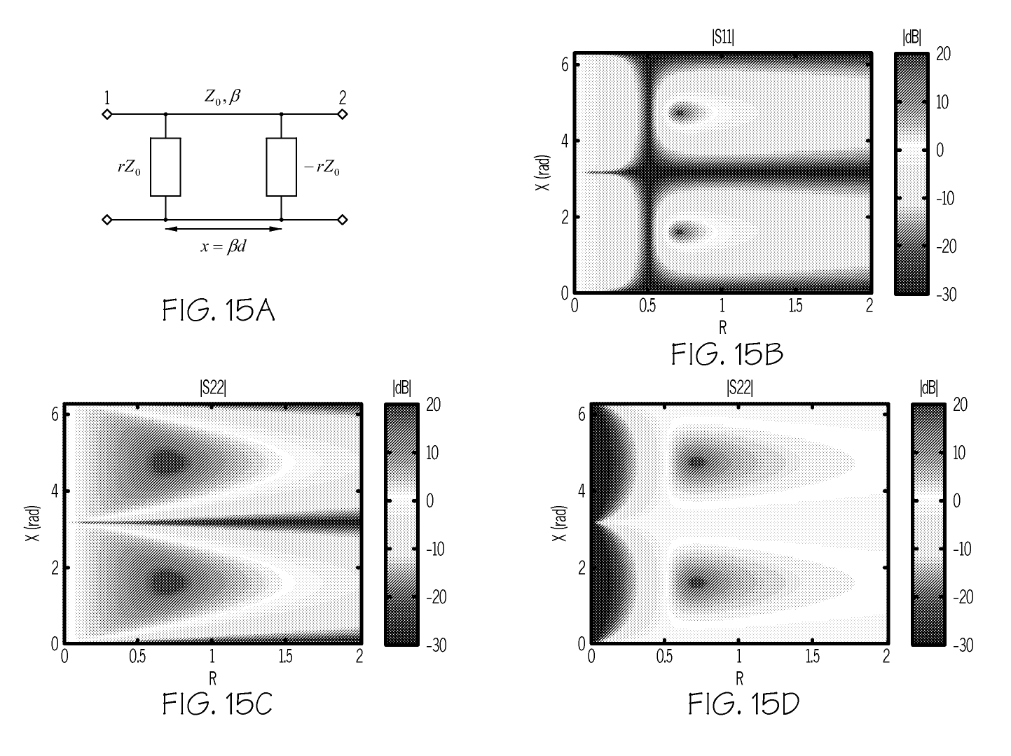

The scattering matrix elements Sᵢⱼ of the system in FIG. 14B can be calculated using the two-port transmission-line network model shown in FIG. 15A. FIG. 15A illustrates the equivalent circuit for the geometry of FIG. 14B in accordance with an embodiment of the present invention. Two parallel lumped resistors are separated by a portion of transmission line with characteristic impedance Z₀ and length x=βd, β being the line propagation constant. The resistors have opposite values ±R, and the dimensionless non-Hermiticity parameter r=R/Z₀ is introduced. The outside medium is also assumed to have characteristic impedance Z₀. If a TE incident polarization is assumed at an arbitrary angle θ, the wave impedance is Z₀=η₀/cos θ, and the propagation constant is β=k₀ cos θ, where η₀ is the characteristic impedance of free-space and k₀=ω\sqrt{μ₀ε₀}. Similar considerations apply to TM incidence, using Z₀=η₀ cos θ. Using the transmission matrix formalism, and assuming time harmonic fields e^{-iωt}, we obtain the scattering parameters

$$\begin{matrix}{S}_{11} = \frac{( 2 r - 1 ) sin ( x )}{sin x - 2 i {r}^{2} {e}^{- i x}} , & ( 17 ) \\ {S}_{22} = \frac{( 2 r + 1 ) sin ( x )}{sin x - 2 i {r}^{2} {e}^{- i x}} , & ( 18 ) \\ {S}_{12} = {S}_{21} = \frac{2 i {r}^{2}}{sin x - 2 i {r}^{2} {e}^{- i x}} . & ( 19 )\end{matrix}$$

The magnitude of the scattering parameters (in dB) is shown in FIGS. 15B-15D, as a function of the variables x and r. FIG. 15B shows the magnitude of S₁₁ in accordance with an embodiment of the present invention. FIG. 15C shows the magnitude of S₂₂ in accordance with an embodiment of the present invention. FIG. 15D shows the magnitude of S₂₁, S₁₁ in accordance with an embodiment of the present invention.

In particular, FIG. 15B shows the magnitude of the reflection coefficient from port 1 (the +R side). For particular values of x and r, spectral singularities are obtained for which the magnitude of the reflection coefficient is infinite, for instance around r=0.7 and x=π/2, as typical for non-Hermitian systems. Remarkably, if one picks r=0.5, corresponding to a resistance being half the background line impedance, the reflection coefficient identically vanishes, regardless of the separation distance x. Under the same condition, FIG. 15D shows that the transmittance to port 2 |S₂₁| is unity. The system is essentially always impedance matched from port one. When excited from port two, however, the reflection is non-zero, as seen in FIG. 15C, while the transmission is again unitary, due to reciprocity. Such a unidirectional reflectionless response, with strong reflection asymmetry, is typical of PT-symmetric structures. However, notice that the proposed system, under the condition r=0.5, is not strictly speaking unidirectional invisible, but instead displays another exotic property that is particularly appealing for the purpose of negative refraction. To see this, the scattering matrix elements is evaluated in Equations (17)-(19) for r=0.5 and arbitrary x:

$$S = ( \begin{matrix}0 & {e}^{- i x} \\ {e}^{- i x} & 2 ( {e}^{- 2 i x} - 1 )\end{matrix} ) . \qquad ( 20 )$$

This unidirectional reflectionless system possesses the fascinating property that the transmitted wave undergoes a phase advance −x that is exactly opposite to the one that it would have without the PT-symmetric metasurface pair. This property implies a negative phase velocity between surfaces, in complete analogy to the case of Veselago lens, confirming the potential of this structure for negative refraction and planar focusing.

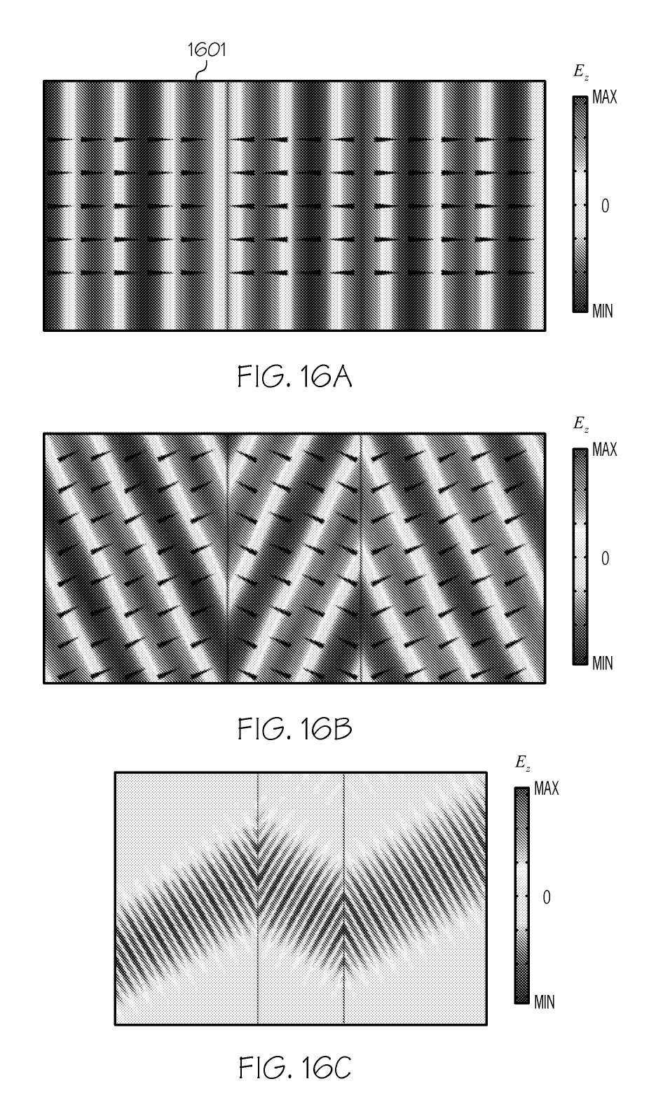

To gain physical insight into this exotic phenomenon, full-wave simulations for an incident electromagnetic field on this PT-symmetric metasurface pair are performed. FIG. 16A shows a snapshot in time of the transverse component of the electric field E_{z} in the case of a plane wave normally incident from the left on a pair of metasurfaces with R=±0.5η₀ in accordance with an embodiment of the present invention. Arrows 1601 in FIG. 16A represent the average Poynting vector. The planar wave fronts and parallel Poynting vector contours are fully restored at port 2, indicating that the pair of metasurfaces is indeed transparent to electromagnetic waves. As predicted by the theoretical considerations, the incident plane wave is not reflected at all, and it is totally transmitted through the structure despite the presence of resistive losses at the first interface, which are fully compensated in this PT-symmetric scenario. Remarkably, the wave between surfaces is propagating in the direction opposite to that of the incident wave, with a power flow sustained by the active −R element and feeding the resistive one. The phase velocity is also reversed in the space between metasurfaces, obeying a PT-symmetric distribution, and providing a phase advance to the transmitted wave.

For oblique incidence, shown in FIG. 16B in accordance with an embodiment of the present invention, the surface impedances are set to the constant value R=±0.5η₀/cos θ, for θ=25°. Here negative refraction is clearly observed between the interfaces, with reversed longitudinal propagation, and power transfer from the active surface to the passive one. It is noted that this phenomenon is significantly different from previous approaches to negative refraction, as the power in the middle region also flows backward, parallel to the phase velocity, fed by the active surface. It is remarkable that, although the gain interface by itself would produce an infinite reflection coefficient (being the parallel combination of R=−Z₀/2 and Z₀, equal to −Z₀), the combined gain-loss system of FIG. 16B is inherently stable. This can be verified by calculating the input impedances at both sides of the system using transmission-line theory, which are different from −Z₀ for any x.

The stability of the system and the infinite reflection coefficient for waves propagating towards the gain surface enforce the existence of only a backward wave between the surfaces when the system is illuminated from the left, as in FIGS. 16A-16C. This wave is coherently synchronized to have the same amplitude and phase as the incident signal when it reaches the passive (left) surface, because this is the only condition under which the left surface can produce zero reflection and total absorption, ensuring no forward wave between the surfaces. At the same time, since the gain (right) surface radiates symmetrically on both sides, the incident wave is perfectly restored at the output. The overall effect is essentially based on the pairing of a coherently lasing metasurface, synchronized to the impinging wave, and a perfectly coherent absorbing metasurface, one being the time-reversal of the other. Its stability may be seen as a particular case of lasing death via asymmetric gain.

The PT-symmetric condition on the metasurface resistances depends on the incidence angle, but with a relatively weak cosinusoidal variation. Therefore, a homogeneous metasurface pair may support negative refraction also in the case of a Gaussian beam excitation with finite waist, as shown in FIG. 16C in accordance with an embodiment of the present invention. The beam is indeed negatively bent by the PT-symmetric pair, without the need of metamaterial effects or strongly non-linear response. Unlike previous methods, this concept is immune from all loss-related issues that inherently characterize passive metamaterials, since the active metasurface exactly compensates the intrinsic loss of the passive one, and it is free from conversion efficiency and pumping issues typical of non-linear wave-mixing schemes. Besides, the metasurfaces employed here are less challenging to realize than highly non-linear metasurfaces required for phase conjugation. They can be realized at radio-frequencies using arrays of dipole antennas loaded with complementary positive and negative resistors, readily obtained at microwaves with tunnel diodes or other semiconductor devices. It should be also stressed that this effect can be inherently broadband, since it does not require any reactive element in the metasurface, which usually restrict the bandwidth.

While the proposed metasurface pair may support partial focusing due to its weak angular dispersion, for ideal planar focusing, all-angle negative refraction is required. In this case, the required surface impedance R=±0.5π₀/cos θ should become nonlocal, as it depends on the incidence angle. This may be realized by properly interconnecting the above-mentioned dipoles, or with other suitable spatial dispersion engineering strategies. An alternative and more convenient way to realize ideal focusing, tailored for a specific location of the focal point, consists in letting the surface impedances Z_{left} and Z_{right} be dependent on the transverse coordinate y. Let us assume that the field E_{z}(y) on the source plane is known, and it is placed at a distance L from the passive metasurface, on the left side. After expanding it in plane waves with complex amplitude \tilde{E}_{z}(k_{y}), the field can be calculated everywhere inside and outside the metasurface pair based on the previous analysis. An ideal negative-index planar lens is required to avoid reflections, to compensate the phase of the propagating portion of the spectrum on the image plane, and to similarly compensate the decay of the evanescent portion of the spectrum. By enforcing these requirements, one can find the required condition on the two surface impedances to be able to sustain this field distribution:

$$\begin{matrix} {Z}_{left} ( y ) = i \frac{{η}_{0}}{2} \frac{{\int }_{- ∞}^{+ ∞} d {k}_{y} {\tilde{E}}_{z} ( {k}_{y} ) {e}^{i {k}_{y} y} {e}^{\sqrt{{k}_{y}^{2} - {k}_{0}^{2} L}}}{{\int }_{- ∞}^{+ ∞} d {k}_{y} \sqrt{\frac{{k}_{y}^{2}}{{k}_{0}^{2}} - 1} {\tilde{E}}_{z} ( {k}_{y} ) {e}^{i {k}_{y} y} {e}^{\sqrt{{k}_{y}^{2} - {k}_{0}^{2} L}}} , & ( 21 ) \\ {Z}_{right} ( y ) = - i \frac{{η}_{0}}{2} \frac{{\int }_{- ∞}^{+ ∞} d {k}_{y} {\tilde{E}}_{z} ( {k}_{y} ) {e}^{i {k}_{y} y} {e}^{\sqrt{{k}_{y}^{2} - {k}_{0}^{2}} ( L - d )}}{{\int }_{- ∞}^{+ ∞} d {k}_{y} \sqrt{\frac{{k}_{y}^{2}}{{k}_{0}^{2}} - 1} {\tilde{E}}_{z} ( {k}_{y} ) {e}^{i {k}_{y} y} {e}^{\sqrt{{k}_{y}^{2} - {k}_{0}^{2}} ( L - d )}} . & ( 22 )\end{matrix}$$

These general formulas provide the surface impedances required to reconstruct E_{z}(y), with infinite resolution, at a distance d−L from the active metasurface on the right side. In the above expressions, the square roots have positive imaginary parts.

If the source is a plane wave incident at an angle θ, \tilde{E}_{z}(k_{y})=δ(k_{y} −k₀sin θ), and Z_{left} =−Z*_{right}*0.5η₀/cos θ is obtained, as in the case studied above. It is stressed that Equations (21)-(22) do not necessarily describe PT-symmetric pairs: first, PT-symmetry requires d=2L, which is a necessary condition to have identical effects of the P and T operators on the field outside the lens (the focal distances on both sides are then equal). After applying this condition, Equations (21)-(22) show that such a lens is PT-symmetric, with Z_{left}(y)=−Z_{right}*(y), as long as the integrals to the propagating portion of the spectrum are truncated in the range |k_{y}|≦k₀. In the general case, involving subwavelength resolution associated with the evanescent portion of the spectrum, Z_{left}(y)≠−Z_{right}*(y), i.e., perfect focusing requires breaking in part the PT-symmetric nature of the device. This is consistent with the fact that evanescent fields are not time-reversible, leading to non PT-symmetric field distributions.

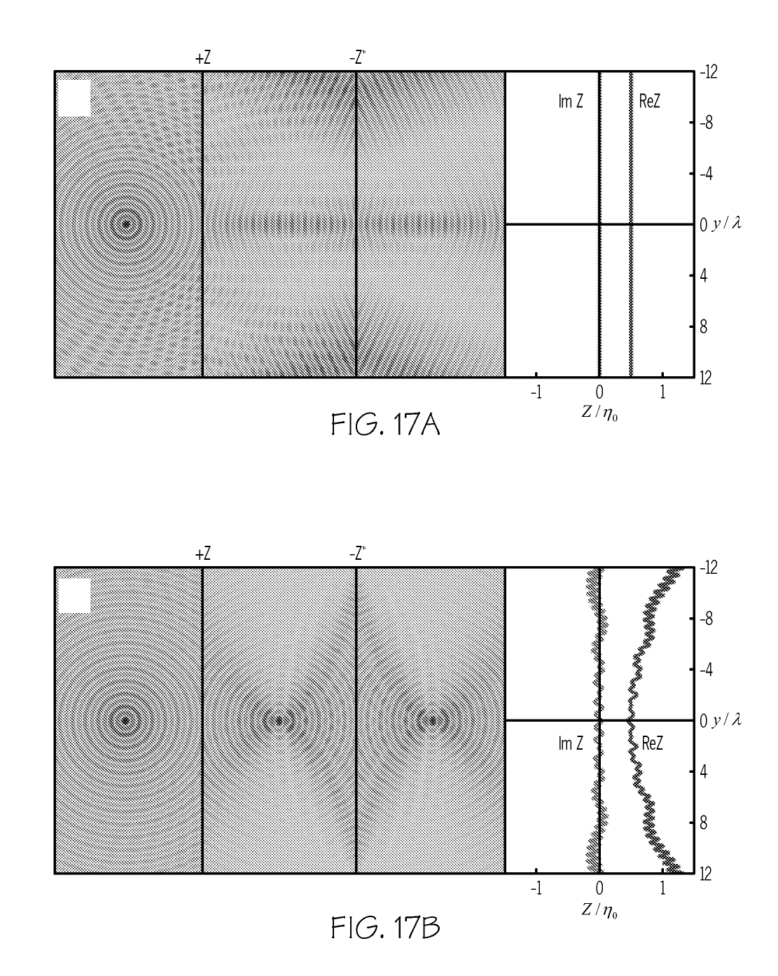

In FIGS. 17A-17B, the potential of a PT-symmetric metasurface pair to ideally focus the propagating portion of the spectrum of an arbitrary source is demonstrated. Two different PT-symmetric scenarios are considered in which a pair of surfaces is excited by a line current oriented along z and placed at a distance L=d/2 6λ₀ on the left of the passive (left) metasurface. FIG. 17A illustrates focusing a point source to a spot whose transverse size is close to the wavelength when the surface impedance Z is constant at 0.5 ηₒ in accordance with an embodiment of the present invention. FIG. 17B illustrates an inhomogeneous surface impedance focusing all propagating spatial harmonics, resulting in a spot size with a transverse size equal to λₒ/2 in accordance with an embodiment of the present invention.

Referring to FIG. 17A, a homogeneous surface pair with R=±0.5η₀ was selected, as in FIG. 16A. This pair supports ideal negative refraction for normal incidence only, but, due to the relatively weak angular dependence of the required resistance, even a local homogeneous impedance can produce partial planar focusing, as demonstrated in FIG. 17A. Efficient focusing of the propagating part of the spectrum is achieved with this homogeneous surface pair, with a hot spot on the image side whose transverse size is comparable to the wavelength.

In FIG. 17B, the PT surface pair is made inhomogeneous following Equation (21) with \tilde{E}_{z}(k_{y})=1/\sqrt{k_{y}²k₀²}. The integral is truncated for |k_{y}|<k₀, and the required inhomogeneous surface impedance is shown in FIG. 17B. In this case, the PT-symmetric pair ideally focuses the propagating spectrum, reaching a focus with transverse size 2₀/2. Resolutions well below the diffraction limit may be obtained by using Equations (21)-(22) with larger spectral windows, but the results presented herein show that efficient planar focusing is already obtained in the case of homogeneous PT-symmetric metasurfaces.

Hence, a novel concept has been proposed to achieve negative refraction without the need for bulk DNG metamaterials or non-linear conjugating surfaces. The approach of the present invention is completely immune to material losses, as it is based on loss-compensated PT-symmetric metasurfaces. The approach of the present invention provides efficient negative refraction and planar focusing with a simple pair of homogeneous metasurfaces with negative and positive surface resistances, which may be implemented linearly at microwave or optical frequencies, or for acoustic waves. The system can be designed to be fully stable and the dispersion of gain and loss elements tailored to have a broadband response, for instance using non-Foster elements. Even though the discussion herein focuses for simplicity on 2D problems and a single polarization, similar considerations apply to 3D setups, by generalizing Equations (21)-(22). This theoretical result opens new possibilities for loss-immune strategies in imaging and unconventional electromagnetic wave manipulation based on PT-symmetric metamaterials.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A metamaterial device, comprising:
a first and a second element with loss and gain, respectively, that exactly compensate each other, wherein an amount of said loss and said gain for said first and second elements, respectively, is tuned by loading said first and second elements with impedances, wherein in response to tuning said amount of said loss and said gain, said metamaterial device is invisible when excited from one side of said metamaterial device and reflective when excited from the other side of said metamaterial device.

2. The metamaterial device as recited in claim 1, wherein a load of said first element comprises passive circuitry, wherein a load of said second element comprises active circuitry.

3. The metamaterial device as recited in claim 2, wherein said active circuitry comprises non-Foster circuit elements.

4. The metamaterial device as recited in claim 1, wherein said first and second elements are electro-mechanical resonators loaded with two different electrical circuits.

5. The metamaterial device as recited in claim 1, wherein said first and second elements are inserted in a waveguide.

6. The metamaterial device as recited in claim 1, wherein said first element absorbs all the energy of an impinging signal, wherein said second element emits a signal synchronized in phase and amplitude with said impinging signal thereby realizing an invisible or undetectable sensor for electromagnetic or acoustic waves.

7. The metamaterial device as recited in claim 6, wherein said first and second elements are loudspeakers loaded with two different electrical circuits.

8. A metamaterial device, comprising;
an outer surface of an object surrounded by a first portion of a metasurface with loss and said outer surface of said objected surrounded by a second portion of said metasurface with gain, wherein said loss and said gain exactly compensate each other, wherein said first portion of said metasurface absorbs all of an incident wave, wherein said second portion of said metasurface re-emits said incident wave thereby making said object non-scattering or cloaked.

9. The metamaterial device as recited in claim 8, wherein said first and second portions of said metasurface are equal portions.

10. The metamaterial device as recited in claim 8, wherein each of said first and second portions of said metasurface cover an opposite half of said outer surface of said object.

11. The metamaterial device as recited in claim 8, wherein said first and second portions of said metasurface are built for electromagnetic or acoustic waves.

12. The metamaterial device as recited in claim 8, wherein said first portion of said metasurface comprises passive circuitry, wherein said second portion of said metasurface comprises active circuitry.

13. The metamaterial device as recited in claim 12, wherein said active circuitry comprises non-Foster circuit elements.

14. A metamaterial device, comprising:
a first metasurface with loss; and
a second metasurface with gain, wherein said gain and said loss compensate each other, wherein said first and second metasurfaces have opposite conjugate surface impedances, wherein a transverse-electric polarized light beam or plane wave obliquely incident on said first and second metasurfaces undergoes negative refraction in free space.

15. A metamaterial device, comprising:
a first metasurface with loss; and
a second metasurface with gain, wherein said gain and said loss compensate each other, wherein said first and second metasurfaces have opposite conjugate surface impedances thereby realizing a lensing or focusing or imaging system.
